(19) United States
(12) Patent Application Publication
(10) Pub. No.: US 2009/0062501 A1
(43) Pub. Date: Mar. 5, 2009

(54) RESOL BEADS, METHODS OF MAKING THEM, AND METHODS OF USING THEM

(75) Inventors: Charles Edwan Sumner, JR., Kingsport, TN (US); Tera Jill Hardin, Elizabethton, TN (US)

Correspondence Address: MICHAEL K. CARRIER, EASTMAN CHEMICAL COMPANY, 100 NORTH EASTMAN ROAD, KINGSPORT, TN, 37660-5075, US

(73) Assignee: EASTMAN CHEMICAL COMPANY, Kingsport, TN (US)

(21) Appl. No.: 11/847,711

(22) Filed: Aug. 30, 2007

(51) Int. Cl. C08G 8/04

(52) U.S. Cl. 528/145

(57) ABSTRACT

Resol beads are disclosed that are prepared in high yield by reaction of a phenol with an aldehyde, in the presence of an effective-variable concentration of a nitrogen-containing base as catalyst, a colloidal stabilizer, and optionally a surfactant. The mean particle size of the resol beads is controlled by varying the effective-variable concentration of the nitrogen-containing base in the reaction mixture, wherein increasing the effective-variable concentration of the nitrogen-containing base produces an increase in the mean particle size of the resol beads. The resol beads obtained have a variety of uses, and may be thermally treated and carbonized to obtain activated carbon beads.

### FIELD OF THE INVENTION

The present invention relates to phenolic resins, and more specifically, to methods useful to control the mean particle size of resol beads made using emulsion polymerization processes, and to resol beads made using such processes.

### BACKGROUND OF THE INVENTION

Phenol-formaldehyde resins are polymers prepared by reacting a phenol with an aldehyde in the presence of an acid or a base, the base-catalyzed phenolic resins being classified as resol-type phenolic resins. A typical resol is made by reacting phenol with an excess of formaldehyde, in the presence of a base such as ammonia, to produce a mixture of methylol phenols which condense on heating to yield low-molecular weight prepolymers, or resols. On heating of the resols at elevated temperature under basic, neutral, or slightly acidic conditions, a high molecular weight network structure of phenolic rings is produced, linked by methylene groups, and typically retaining residual methylol groups.

GB 1,347,878 discloses a process in which phenol or a phenol derivative is condensed with formaldehyde in aqueous solution, in the presence of a catalyst which is an organic or an inorganic base, and in a homogeneous phase, to obtain a resin in the form of a suspension of oily droplets in the reaction medium, the suspension being stabilized by the addition of a dispersing agent which prevents the coalescence of the droplets. The process described results in spherical beads of phenolic resin that may be separated, washed, and dried, that are said to be useful for a variety of purposes, for example as filling material or for lightening the weight of such traditional materials as cement or plaster.

GB 1,457,013 discloses cellular, spherical beads having a high carbon content, containing a plurality of closed cells, wherein the walls of the peripheral cells form a continuous skin marking the limits of the external surface. The beads may be comprised of an organic precursor material, which can be a phenoplast, and the process by which they are made includes a carbonization step.

U.S. Pat. No. 3,850,868 discloses reacting urea or phenol and formaldehyde in a basic aqueous medium to provide a prepolymer solution, blending the prepolymer in the presence of a protective colloid-forming material, subsequently acidifying the basic pre-polymer solution so that particles are formed and precipitated in the presence of a colloid-forming material, as spheroidal beads, and finally collecting and, if desired, drying the urea or phenol formaldehyde particulate beads. The resulting beads are said to have a high flatting efficiency making them suitable for low gloss coating compositions.

U.S. Pat. No. 4,026,848 discloses aqueous resole dispersions produced in the presence of gum ghatti and a thickening agent. The dispersions are said to have enhanced utility in such end-use applications as coatings and adhesives.

U.S. Pat. No. 4,039,525 discloses aqueous resol dispersions produced in the presence of certain hydroxyalkylated gums, such as hydroxyalkylated guar gums, as interfacial agents.

U.S. Pat. No. 4,206,095 discloses particulate resols produced by reacting a phenol, formaldehyde, and an amine in an aqueous medium containing a protective colloid, to produce an aqueous suspension of a particulate resol, and recovering the particulate resol from the suspension.

U.S. Pat. No. 4,316,827 discloses resin compositions useful as friction particles that include a mixture of tri- and/or tetrafunctional and difunctional phenols, an aldehyde, an optional reaction-promoting compound, a protective colloid, and a rubber. In a first step condensation reaction, the rubber can be incorporated either in the interior or incorporated on the surface of the resin particles. The condensation product is subjected to a second step under acidic conditions, which results in a product in particulate form that is said to require no grinding or sieving when used as a friction particle.

U.S. Pat. No. 4,366,303 discloses a process for producing particulate resol resins that comprises reacting formaldehyde, phenol and an effective amount of hexamethylenetetramine or a compound containing amino hydrogen, or mixtures thereof, in an aqueous medium containing an effective amount of a protective colloid for a sufficient time to produce a dispersion of a particulate resol resin; cooling the reaction mixture to below about 40° C.; reacting the cooled reaction mixture with an alkaline compound to form alkaline diphenates; and recovering from the aqueous dispersion a resin exhibiting increased cure rates and increased sinter resistance.

U.S. Pat. No. 4,182,696 discloses solid particulate, heat-reactive, filler-containing molding compositions that are directly produced by reacting a phenol, formaldehyde, and an amine in an aqueous medium containing a water-insoluble filler material having reactive sites on the surface thereof that chemically bond with a phenolic resin and protective colloid to produce an aqueous suspension of a particulate filler-containing resol, and recovering the filler-containing resole from the suspension. The filler materials may be in the form of fibrous or non-fibrous particles and may be inorganic or organic.

U.S. Pat. Nos. 4,640,971 and 4,778,695 disclose a process for producing a resol resin in the form of microspherical particles of a size not exceeding 500 μm by polymerizing phenols and aldehydes in the presence of a basic catalyst and a substantially water-insoluble inorganic salt. Preferred inorganic salts, which include calcium fluoride, magnesium fluoride, and strontium fluoride, partially or entirely cover the surface of the resulting microspherical particles.

U.S. Pat. No. 4,748,214 discloses a process for producing microspherical cured phenolic resin particles having a particle diameter of not more than about 100 μm by reacting a novolak resin, a phenol, and an aldehyde in an aqueous medium in the presence of a basic catalyst and an emulsion stabilizer. The novalak resin employed in the process is obtained by heating a phenol and an aldehyde in the presence of an acidic catalyst such as hydrochloric acid or oxalic acid to effect polymerization, dehydrating the polymerization product under reduced pressure, cooling the product, and coarsely pulverizing it.

U.S. Pat. No. 4,071,481 discloses phenolic foams, mixtures for producing them, and their processes of manufacture. The resin used is a base catalyzed polycondensation product of phenol and formaldehyde which is obtained in a solid, reactive, fusible, substantially anhydrous state. The resin is foamed and hardened by the application of heat without the use of a catalyst. Heat sensitive blowing agents, either in liquid form or in particulate form may be mixed with the resin prior to heating. Surfactants and lubricants may be utilized to enhance the uniformity of the voids in the foam. The resulting foams are said to be non-acidic, resistant to color changes, and substantially anhydrous.

U.S. Pat. No. 5,677,373 discloses a process for producing a dispersion, wherein dispersed slightly crosslinked polyvinyl seed particles are swollen with an ionizing liquid, the seed particles containing covalently linked ionizable groups causing a swelling of the seed particles by the ionizing liquid to form a dispersion of droplets, wherein the resulting droplets after the swelling have a volume which is at least five times that of the seed particles. The ionizing liquid may be or contain a polymerizable monomer or may be charged with such a monomer. Polymerization of the monomers is said to be effected in the droplets during or after the swelling, to form polymer particles.

Chinese Pat. Discl. No. CN 1240220A discloses a method for manufacturing a phenol-formaldehyde resin-based spherical activated carbon that includes mixing together a linear phenol-formaldehyde resin and a curing agent to form a block mixture, crushing the block mixture to form particles of a resin raw material, dispersing the resin raw material in a dispersion liquid that contains a dispersing agent, emulsifying the material to form spheres, and carbonizing and activating the resulting spheres

JP 63-48320 A discloses a method for manufacturing a particulate phenolic resin, in which a particulate obtained from a condensation product aggregating around a core substance is produced by subjecting a phenol and an aldehyde to a condensation reaction in the presence of a dispersant and the core substance. The particulate is then dehydrated and dried. The core substance can be either an organic or an inorganic material. The particulate material obtained is characterized as being relatively soluble in acetone.

Japanese Pat. Publn. No. JP 10-338511 A discloses a spherical phenolic resin having a particle diameter from 150 to 2,500 μm obtained by condensing phenols and aldehydes in the presence of a dispersant with a nucleus material, by causing the condensation product to aggregate around the nucleus material. A phenolic resin, glass granules, SiC, mesophase carbon, alumina, graphic, and phlogopite, are said to be useful as nucleus material.

U.S. patent application Ser. Nos. 11/353,814, filed on Feb. 14, 2006, and 11/594,379, filed on Nov. 8, 2006, having common assignee herewith, the disclosures of which are incorporated herein by reference in their entirety, disclose processes for producing resol beads, the processes comprising reacting a phenol with an aldehyde, in the presence of a base as catalyst, in an agitated aqueous medium provided with a colloidal stabilizer, optionally a surfactant, and previously-formed resol beads, for a period of time and at a temperature sufficient to produce an aqueous dispersion of resol beads.

Beads comprised of phenolic polymers may thus be made using various methods and have a variety of uses, and for many uses the particle size and particle size distribution may not be especially important. However, for other uses, particle size may well be an important factor, for example when a carbonized product is desired having particular transport or adsorption properties. It may also be important to obtain particles having a relatively narrow particle size distribution, for example when the bulk flow properties of a carbonized product are important, such as to facilitate flow of the particles, or when predictable packing of the particles is necessary or helpful.

For example, U.S. Pat. Publ. No. 2003/0154993 A1, which discloses cigarettes that include a tobacco rod and a filter component having a cavity filled with spherical beaded carbon, emphasizes the importance of obtaining point-to-point contact between the spherical beads together with substantially complete filling of the cavity so as to produce minimal channeling of ambulatory gas phase as well as maximum contact between the gas phase and the carbon surface of the spherical beads during smoking.

In many cases, then, controlling the mean particle size and particle size distribution of beads may be desirable. For example, a relatively large mean particle size may be desired, in certain cases, in order to assist in the handling of the material, or when it is desirable to provide a bead the interior of which includes portions that are relatively distant from the surface of the beads. There remains a need in the art to identify and optimize parameters that affect the particle size of such beads, especially when a relatively large mean particle size is desired, with a satisfactory yield.

### SUMMARY OF THE INVENTION

According to the present invention there is provided a method for obtaining a predetermined mean particle size of resol beads produced in a process comprising:

forming a reaction mixture comprising a phenol, an aldehyde, and an effective-variable concentration of a nitrogen-containing base as catalyst, in an agitated aqueous medium provided with a colloidal stabilizer and optionally a surfactant, to form a reaction mixture;

allowing the reaction mixture to react for a period of time and at a temperature sufficient to produce an aqueous dispersion of resol beads; and

recovering from the aqueous dispersion resol beads, the method comprising:

selecting a predetermined mean particle size for the resol beads, and

selecting a corresponding effective-variable concentration of the nitrogen-containing base in the reaction mixture according to a correlation whereby increasing the effective-variable concentration increases the mean particle size, so as to produce, or approximate, the desired mean particle size of the resol beads.

In other aspects of the invention, there are provided methods as set forth on the sub-claims hereinafter.

In one aspect, the invention relates to methods for producing resol beads having a predetermined, or target, mean particle size, in processes including the steps of forming a reaction mixture comprising a phenol, an aldehyde, and an effective-variable concentration of a nitrogen-containing base as catalyst, in an agitated aqueous medium provided with a colloidal stabilizer and optionally a surfactant, to form a reaction mixture; allowing the reaction mixture to react for a period of time and at a temperature sufficient to produce an aqueous dispersion of resol beads; and recovering from the aqueous dispersion resol beads having the controlled mean particle size, the target mean particle size being achieved by varying the effective-variable concentration of the nitrogen-containing base in the reaction mixture, such that increasing the effective-variable concentration of the nitrogen-containing base produces an increase in the mean particle size of the resol beads.

A range of predetermined mean particle sizes may be obtained according to the invention, for example a mean particle diameter in the range from about 40 μm to about 500 μm, or from 60 μm to 400 μm, or from 80 μm to 360 μm, or as described elsewhere herein.

In another aspect of the invention, the effective-variable concentration of the nitrogen-containing base useful according to the invention may range widely, for example from about 0.3 mole to about 0.7 mole per kilogram of reaction mixture, or from about 0.4 mole to about 0.6 mole per kilogram of reaction mixture, or as described elsewhere herein.

In yet another aspect, the phenol compound and the nitrogen-containing base may be present in the reaction mixture in a wide range of molar ratios, for example from about 0.1 to about 0.24 mole of nitrogen-containing base per mole of phenol compound, or as described elsewhere herein.

In one aspect, a variety of phenols may be used according to the invention, for example monohydroxybenzene, or those phenols described elsewhere herein. In a further aspect, a variety of aldehydes may be used according to the invention, for example formaldehyde, or other aldehydes as described elsewhere herein. Similarly, a variety of nitrogen-containing bases may be useful according to the invention, for example ammonia or ammonium hydroxide, or one or more amines, or as described elsewhere herein.

A variety of temperatures may be used according to the invention sufficient to produce an aqueous dispersion of resol beads, for example a temperature within the range from about 70° C. to about 100° C., or from 75° C. to 90° C., or as described elsewhere herein. Similarly, the reaction mixture may be allowed to react for a variety of time periods, for example from about 2 hours to about 8 hours, or from or from 4 hours to 8 hours, or from 4 hours to 6 hours.

According to one aspect, a variety of colloidal stabilizers may be used according to the invention, for example carboxymethylcellulose, or other colloidal stabilizers described elsewhere herein.

In another aspect, the reaction mixture may further comprise one or more surfactants, for example sodium dodecyl sulfate, or other surfactants as described elsewhere herein or known in the art.

In yet another aspect, the reaction mixture may further comprise previously-formed resol beads, which may have a variety of median particle sizes, for example from 75 μm to 750 μm, or as described elsewhere herein.

In a further aspect, the resol beads recovered may have a variety of median particle sizes, for example having a median particle size from about 10 μm to about 2,000 μm, or as described elsewhere herein.

In yet another aspect, the previously-formed resol beads may be provided in various amounts, for example in an amount of at least 10 wt. %, based on the weight of the phenol.

In a further aspect, the aldehyde and the phenol may be present in various amounts and in various ratios, for example in a molar ratio of the aldehyde to the phenol from about 1.1:1 to about 3:1, or as described elsewhere herein.

In yet another aspect, the optional previously-formed resol beads may be provided to the reaction mixture in various amounts, for example in an amount such that the total external surface area of the previously-formed resol beads provided is at least 4 m² per each kilogram of phenol, or as described elsewhere herein.

In yet another aspect, the process may be carried out with various process details, for example such that the process further comprises adding, after the reacting has begun, a further portion of the nitrogen-containing base, or in a variety of batch, semi-batch, and continuous processes as described elsewhere herein.

In yet another aspect, the resol beads recovered may have an acetone solubility of no more than 30%, or as described elsewhere herein, and may have a density, for example, of from about 0.3 g/mL to about 1.3 g/mL.

Further aspects of the invention are as disclosed or claimed below.

### DETAILED DESCRIPTION OF THE INVENTION

The present invention may be understood more readily by reference to the following detailed description of the invention, and to the examples provided. It is to be understood that this invention is not limited to the specific processes and conditions described, because specific processes and process conditions for processing articles according to the invention may vary. It is also to be understood that the terminology used is for the purpose of describing particular embodiments only and is not intended to be limiting.

As used in the specification and the claims, the singular forms “a,” “an,” and “the” include plural referents unless the context clearly dictates otherwise.

By “comprising” or “containing” we mean that at least the named compound, element, particle, etc. must be present in the composition or article, but does not exclude the presence of other compounds, materials, particles, etc., even if the other such compounds, material, particles, etc. have the same function as what is named.

When we say that the nitrogen-containing base is present in or is provided to the reaction mixture in an effective-variable concentration, we mean that the concentration is sufficient to obtain the desired mean particle size. Thus, providing an effective-variable concentration of a nitrogen-containing base as catalyst to the reaction mixture results in resol beads being formed having a controlled mean particle size, the mean particle size being controlled by varying the effective-variable concentration of the nitrogen-containing base in the reaction mixture, such that increasing the effective-variable concentration of the nitrogen-containing base produces an increase in the mean particle size of the resol beads.

We have found that the mean particle size correlates with the concentration of the nitrogen-containing base present in the reaction mixture, and that higher concentrations result in larger mean particle sizes for the resol beads obtained. For example, the present application discloses that ammonia concentrations ranging from about 0.309 M to about 0.662 M resulted in resol beads being formed having mean particle diameters from about 68 μm to about 362 μm, respectively, with higher ammonia concentrations correlating with higher mean particle sizes.

In one aspect, the invention provides resol beads that comprise the reaction product of a phenol with an aldehyde, reacted in a basic agitated aqueous medium containing a colloidal stabilizer, optionally previously-formed resol beads, and optionally a surfactant. The optional previously-formed resol beads, also referred to herein as previously-formed beads and as seed particles, may assist in obtaining a desired particle size and particle size distribution. The processes according to the invention may be carried out batch-wise, in semi-batch fashion, or continuously, as further described below.

In a significant aspect, we have discovered that the average size of the resol beads obtained, as well as the total yield of resol beads that may be recovered, can be controlled by the concentration of nitrogen-containing base used as catalyst in the synthesis, for example ammonia. Although one skilled in the art might expect that increasing the concentration of such base in the agitated aqueous medium might increase the rate of reaction, we have surprisingly found that higher concentrations of nitrogen-containing base also result in both a larger mean particle size and a higher yield of recoverable beads (from reduced fines formation), given a comparable amount of agitation. In order to obtain satisfactory results according to the invention, the rate of agitation may be adjusted according to the concentration of base in the aqueous medium, and, in general, higher concentrations may require more agitation. Undue clumping may be avoided, when desired, by proper selection of concentration of nitrogen-containing base, temperature of reaction, and amount of agitation, as further described herein.

Although previously-formed resol beads may be used according to the invention as seeds, we have found that proper selection of concentration of the base is sufficient in many instances to obtain a desired (i.e. predetermined, or target) mean particle size and particle size distribution, although the use of previously-formed beads may assist in some instances in obtaining a desired particle size or particle size distribution, as further described elsewhere herein.

In a typical batch process, the resol beads may be prepared, for example, by combining in an agitated aqueous medium a phenol and an aldehyde, optionally in the presence of previously-formed resol beads, and in the presence of a nitrogen-containing base such as ammonium hydroxide as catalyst, a colloidal stabilizer such as carboxymethylcellulose sodium, and optionally a surfactant such as sodium dodecylsulfate, and reacting them together at a temperature and time sufficient to obtain the desired product. In semi-batch processes, one or more of the foregoing may be added to the reaction mixture during the course of the reaction.

In one aspect, the invention thus provides resol beads having a predetermined mean particle size, the resol beads comprising the reaction product of a phenol and an aldehyde, reacted in the presence of a nitrogen-containing base as catalyst, for example in a basic, agitated aqueous medium that includes a colloidal stabilizer, and optionally a surfactant. According to the invention, an effective-variable concentration of a nitrogen-containing base as catalyst is provided, the concentration being an amount sufficient to obtain a desired mean particle size, the mean particle size being controlled by varying the effective-variable concentration of the nitrogen-containing base in the reaction mixture, wherein increasing the effective-variable concentration of the nitrogen-containing base produces an increase in the mean particle size of the resol beads. A further advantage of using an effective-variable concentration of a nitrogen-containing base is that a satisfactory yield may be obtained, since amounts sufficient to obtain a larger mean particle size also results in a reduction in the production of fines, which are small particles that are difficult to separate and isolate from the reaction mixture.

In yet another aspect, the method of the invention may be carried out in processes for producing resol beads, the processes including a step of reacting a phenol with an aldehyde, in the presence of an effective-variable concentration of a nitrogen-containing base as catalyst, in an agitated aqueous medium that includes a colloidal stabilizer, and optionally a surfactant, optionally in the presence of previously-formed resol beads, for a period of time and at a temperature sufficient to produce an aqueous dispersion of resol beads. The optional previously-formed resol beads may be obtained, for example, as under-sized resol beads produced in a previous batch, or in the case of a continuous or semi-continuous process, as recycled beads obtained at any earlier point in the process.

In yet another aspect, the method of the invention may be carried out in the context of processes for producing resol beads, the processes including:
a) reacting a phenol with an aldehyde in the presence of an effective-variable concentration of a nitrogen-containing base as catalyst, in an agitated aqueous medium that includes a colloidal stabilizer, and optionally a surfactant, for a period of time and at a temperature sufficient to produce an aqueous dispersion of resol beads;
b) recovering the water-insoluble resol beads from the aqueous dispersion;
c) separating beads below a minimum particle size; and
d) recycling the beads below a minimum particle size to the aqueous medium of step a).

In yet another aspect, the method of the invention may be carried out in the context of processes for producing resol beads, the processes including:

a) reacting a phenol with an aldehyde in the presence of an effective-variable concentration of a nitrogen-containing base as catalyst, in an agitated aqueous medium that includes a colloidal stabilizer, and optionally a surfactant, for a period of time and at a temperature sufficient to produce an aqueous dispersion of resol beads;

b) recovering water-insoluble resol beads above a minimum particle size from the aqueous dispersion; and

c) retaining or recycling beads below the minimum particle size in the aqueous dispersion of resol beads.

In yet another aspect, the method of the invention may be carried out in the context of processes for producing resol beads, the processes including:

a) reacting a phenol with an aldehyde in the presence of an effective-variable concentration of a nitrogen-containing base as catalyst, in an agitated aqueous medium that includes a colloidal stabilizer, and optionally a surfactant, for a period of time and at a temperature sufficient to produce an aqueous dispersion of resol beads;

b) recovering water-insoluble resol beads above a minimum particle size from the aqueous dispersion; and

c) retaining or recycling beads within a desired particle size range in or to the aqueous dispersion of resol beads.

The resol beads of the invention may have a variety of target particle sizes and particle size distributions. In further steps, the beads may be cured or partially cured, and afterward used or further processed, such as by carbonization and activation, to obtain, for example, activated carbon beads.

In the bead formation processes, the reactants may be combined in a batch process, or one or more of the reactants or catalysts may be added over time, alone or together, in semi-batch mode. Further, the processes according to the invention may be carried out continuously or semi-continuously, in a variety of reaction vessels and with a variety of agitation means, as further described herein.

Thus, in one aspect, the invention relates to processes for producing resol beads, the processes including a step of providing a phenol, at least a portion of an aldehyde, and at least a portion of an effective-variable concentration of a nitrogen-containing base as catalyst to a reaction mixture which is an agitated aqueous medium that includes a colloidal stabilizer, optionally a surfactant, and optionally previously-formed resol beads; reacting for a period of time and at a temperature sufficient to produce an aqueous dispersion of resol beads; and thereafter adding any remaining portion of the base and the aldehyde over a period of time, such as about 45 minutes. The optional previously-formed resol beads may be obtained, for example, as under-sized resol beads produced in a previous batch, or in the case of a continuous or semi-continuous process, as recycled beads obtained at any earlier point in the process.

In yet another aspect, the method of the invention may be used in processes for producing resol beads, the processes including a step of providing at least a portion of a phenol, at least a portion of an aldehyde, and at least a portion of an effective-variable concentration of a nitrogen-containing base as catalyst to a reaction mixture which is an agitated aqueous medium that includes a colloidal stabilizer, optionally a surfactant, and optionally previously-formed resol beads; reacting for a period of time and at a temperature sufficient to produce an aqueous dispersion of resol beads, for example up to about two hours; thereafter a further portion of the phenol, a further portion of the aldehyde, and a further portion of a base as catalyst are added to the reaction mixture and reacted, for example for an additional two hours; and thereafter adding any remaining portion of the phenol, the aldehyde, and the base over a period of time and at a temperature sufficient to obtain the desired resol beads. The optional previously-formed resol beads may be obtained, for example, as under-sized resol beads produced in a previous batch, or in the case of a continuous or semi-continuous process, as recycled beads obtained at any earlier point in the process.

In yet another aspect, the method of the invention may be carried out in processes as hereinbefore described, with a further portion of a base added after the reactants have begun reacting, or even when the reaction is otherwise substantially completed, the base being the same as or different from that already added to the reaction mixture as a catalyst for the reaction. Alternatively, a portion of acid may be added after the reaction is begun or is substantially completed, or the processes described may be followed by a period of curing at an elevated temperature.

In one aspect, the method of the invention may be carried out in processes for producing resol beads, the processes including:

a) reacting a phenol with an aldehyde in the presence of an effective-variable concentration of a nitrogen-containing base as catalyst, in an agitated aqueous medium that includes a colloidal stabilizer, and optionally a surfactant, for a period of time and at a temperature sufficient to produce an aqueous dispersion of resol beads;

b) recovering the water-insoluble resol beads from the aqueous dispersion;

c) separating beads below a minimum particle size; and

d) recycling the beads below a minimum particle size to the aqueous medium of step a), wherein the beads that are recycled are not further processed, for example by thermal curing, treating with either an acid or a base, or by coating the beads, prior to being recycled.

Thus, in one aspect, the previously formed beads to be recycled are not further cured prior to recycling, for example by thermal curing. Similarly, in another aspect, the previously formed beads to be recycled are not treated, for example with an acid or a base, and are at most removed from the reaction mixture and rinsed with water prior to recycling. In another aspect, the previously formed beads to be recycled are not substantially dried prior to being recycled, but are simply provided to the reaction mixture in a water-wet state as a result, for example, of physical filtering of the material, optionally with sorting carried out based on the size of the particles. In a similar aspect, the previously formed beads are not coated prior to recycling with an additional material such as, for example, a wax, carnauba wax, gum arabic, or the like, prior to recycling. In this aspect, the recycled beads are thus not coated prior to being recycled.

In one aspect, the resol beads, when isolated from the reaction mixture in which they are formed, and optionally washed only with water, include measurable amounts of nitrogen, derived for example from the use of ammonia or ammonium hydroxide as catalyst, either as such or provided by hexamethylenetetramine used as a source of both ammonia and formaldehyde. In various aspects, the amount of nitrogen present in the resol beads of the invention isolated from the reaction mixture may be, for example, at least 0.5% nitrogen, or at least 0.8%, or at least 1%, up to about 2.0% nitrogen, or up to 2.5%, or up to 2.6%, or up to 3%, or more, nitrogen. The amount of nitrogen may be measured, for example, as elemental analysis carried out using a ThermoFinnigan FlashEA™ 112 Elemental Analyzer. In a particular aspect, the amount of nitrogen is from about 1% to about 2.6%, based on elemental analysis carried out on a ThermoFinnigan FlashEA™ 112 Elemental Analyzer.

The resol beads isolated from the reaction mixture are further characterized as containing material, including phenol, hydroxymethyl phenol, and oligomers, that can be extracted into methanol. The extractable material includes nitrogen, typically in an amount less than about 1.1% nitrogen, by weight of the resol beads. The total amount of extractable material typically comprises, for example, from about 1% to about 20%, or from 3% to 15%, of the mass of the resin beads.

Interestingly, we have found that the extracting of this material does not substantially affect the recyclability of the beads, that is, the use of the previously formed beads as seeds. Without wishing to be bound by theory, the recyclability of the beads appears instead to be a function of the degree of cross-linking in the resin bead.

Thus, in one aspect, the previously-formed resol beads obtainable according to the invention are relatively insoluble in methanol, that is, are soluble in amounts up to about 15 wt. %, or up to about 20 wt. %, or up to about 25 wt. %, in each case based on the weight of the beads prior to methanol extraction.

We have found that the resol beads of the invention useful as previously-formed beads are typically yellow in color, based on visual inspection. This is contrasted with cured beads, which typically appear to be light brown, tan, or red in color. The reason for this is unclear, but this phenomenon likewise appears to be a function of the amount of cross-linking in the resol polymer.

In another aspect, we have found that active beads, that is, beads that are useful as seeds, or previously-formed beads, typically have a T_{g} from about 30° C. to about 120° C., or from about 30° C. to about 68° C., as measured by DSC. This is contrasted with beads that have lost substantial activity as previously-formed beads, and are characterized as having no measurable T_{g}. As is methanol solubility, this is seen to be a measure of the cross-linking of the resol polymer of which the beads are formed.

In yet another aspect, previously formed beads that are useful as seeds are typically swellable in DMSO to at least 110% of their original diameter. This, likewise, is a measure of cross-linking. Previously formed beads that have lost substantial activity as seeds typically do not appreciably swell in DMSO. Without wishing to be bound by theory, this appears also to be a function of the amount of cross-linking.

The resol beads obtained by the method of the invention, for example when isolated as an aqueous suspension of resol beads from a reaction mixture in which they are formed, are relatively insoluble in acetone. This relative insolubility in acetone may likewise be considered a measure of the degree of polymerization or cross-linking which has occurred in the beads. The acetone solubility of the resol beads obtained may thus be, for example, no more than about 5%, or no more than 10%, or no more than 15%, or no more than 20%, or no more than 25%, or no more than 26%, or no more than 30%, or no more than 45%, in each case as measured by comparison of the weight of residue produced by evaporation of the acetone solvent to the starting weight of the beads. Alternatively, the amount of acetone solubility may be from about 5% to about 45%, or from 10% to 30%, or from 10% to 26%, in each case as measured by comparison of the weight of residue produced by evaporation of the acetone solvent to the starting weight of the beads.

Factors that are believed to affect the amount of acetone solubility include the temperatures at which the reaction is carried out, and the length of time during which the reaction is carried out. Advantages of avoiding substantial amounts of acetone solubility include handling of the product, e.g. drying and storage. Beads having substantial acetone solubility would be expected to be difficult to process, for example sticking together and forming clumps.

The resol beads are further characterized as being relatively infusible, that is, resistant to melting. Thus, when the beads are heated, the resin does not flow, but eventually produces a char. This property likewise is a function of the degree of polymerization or cross-linking that has taken place in the beads, and can be considered characteristic of resol polymers as distinguished from novolak polymers, in which substantial cross-linking requires the use of a separate cross-linking agent, often called a curing agent.

Similarly, the resol beads do not substantially deform when shear is applied, but rather tend to shatter or fragment. This, likewise, is an indication of substantial cross-linking having taken place.

The density of the resol beads isolated from the reaction mixture is typically at least 0.3 g/mL, or at least 0.4 g/mL or at least 0.5 g/mL, up to about 1.2 g/mL or up to about 1.3 g/mL, or from about 0.5 to about 1.3 g/mL.

In yet another aspect, the invention provides activated carbon beads having a desired particle size and particle size distribution, the activated carbon beads comprising the reaction product of a phenol with an aldehyde as already described, carried out in the presence of an effective-variable concentration of a nitrogen-containing base as catalyst, reacted in an agitated aqueous medium that includes a colloidal stabilizer, and optionally a surfactant, and thereafter thermally treated, with agitation, carbonized, and activated, via one or more intermediate processing steps, as further described herein. In yet another aspect, the invention relates to methods of producing the activated carbon beads just described.

In yet another aspect, the invention provides activated carbon beads having a desired particle size and particle size distribution, the activated carbon beads comprising the reaction product of a phenol with an aldehyde carried out in the presence of an effective-variable concentration of a nitrogen-containing base as catalyst, reacted in an agitated aqueous medium that includes a colloidal stabilizer, and optionally a surfactant, and thereafter thermally treated, with agitation, carbonized, and activated, via one or more intermediate processing steps, as further described herein.

As used herein, the term “beads” is intended to refer simply to approximately spherical or round particles, and in some embodiments, the shape may serve to improve the flow properties of the beads during subsequent processing or use. The resol beads obtained according to the invention will typically be approximately spherical, but with a range of sphericity (SPHT) values. Sphericity, as a measure of the roundness of a particle, may be calculated using the following equation:

$$SPHT = \frac{4 π A}{{U}^{2}}$$

in which SPHT is the sphericity value obtained;
U is the measured circumference of a particle; and
A is the measured (projected) surface area of a particle.

For an ideal sphere, the calculated SPHT would be 1.0; any less spherical particles would have an SPHT value less than 1.

The sphericity values of the resol beads of the invention referred to herein, as well as those of the activated carbon beads of the invention referred to herein, may be determined using a CamSizer, available from Retsch Technology GmbH, Haan, Germany, the CamSizer being calibrated using NIST Traceable Glass Microspheres, available from Whitehouse Scientific, Catalog Number XX025, Glass Microsphere calibration standards, 366+/−2 microns, 90% between 217 and 590 microns.

The resol beads obtained according to the claimed invention will typically have SPHT values, for example, of at least about 0.80, or at least about 0.85, or at least 0.90, or even at least 0.95. Suitable ranges of sphericity values may thus range, for example, from about 0.80 to 1.0, or from 0.85 to 1.0, or from 0.90 to 0.99.

The term resol is likewise not intended to be particularly limited, referring to the reaction product of a phenol and an aldehyde in which the reaction is carried out in the presence of a base as catalyst. Typically, the aldehyde is provided in molar excess. The term resol is not intended, as used herein, to refer only to prepolymer particles having only a minor amount of cross-linking or polymerization having taken place, but instead refers to the reaction product at any stage from the initial reaction of a phenol with an aldehyde through the thermosetting stage when significant crosslinking has occurred.

The resol beads according to the invention may be used for a variety of purposes for which resol beads are known to be useful, and find ready application in the formation of activated carbon beads when thermally treated and subjected to carbonization and activation, as further described below, for a wide range of end uses, such as in cigarette filters, in clothing for protecting persons from chemical and biological warfare agents, as medical adsorbents, for gas masks used in chemical spill cleanup, and the like.

The term “cured resol beads” is intended to describe resol beads, as just described, which have been thermally cured to reduce the tendency of the resol beads to stick to one another, as further described herein. The cured resol beads may be useful for a variety of purposes for which resol beads are known to be useful, including those in which the resol polymer of which the beads are comprised has not yet substantially cross-linked, the amount of curing in some instances being only that needed to reduce the tendency of the resol beads to stick to one another. The times, temperatures, and conditions under which the resol beads are thermally cured to obtain the cured resol beads of the invention are as further defined herein.

The general terms “phenol” and “one or more phenols” as used herein mean phenols of the type that form condensation products with aldehydes, including, in addition to phenol (monohydroxybenzene), other monohydric and dihydric phenols such as phenol, pyrocatechol, resorcinol, or hydroquinone; alkyl-substituted phenols such as cresols or xylenols; binuclear or polynuclear monohydric or polyhydric phenols such as naphthols, p,p′-dihydroxydiphenyl dimethylmethane or hydroxyanthracenes; and compounds which, in addition to containing phenolic hydroxyl groups, include such additional functional groups as phenol sulfonic acids or phenol carboxylic acids, such as salicylic acid; or compounds capable of reacting as phenolic hydroxyls, such as phenol ethers. Phenol itself is especially suitable for use as a reactant, is readily available, and is more economical than most of the phenols just described. The phenols used according to the invention may be supplemented with nonphenolic compounds such as urea, substituted ureas, melamine, guanamine, or dicyandiamine, for example, which are able to react with aldehydes as do phenols. These and other suitable compounds are described in U.S. Pat. No. 3,960,761, the relevant portion of which is incorporated herein by reference.

In one aspect, the phenol used is one or more monohydric phenols, present in an amount of at least 50%, with respect to the total weight of the phenols used, or at least 60%, or at least 75%, or at least 90%, or even at least 95% monohydric phenols, in each instance based on the total weight of the phenols used.

In another aspect, the phenol used is phenol, that is, monohydroxybenzene, for example present in an amount of at least 50%, with respect to the total weight of the phenols used, or at least 60%, or at least 75%, or at least 90%, or even at least 95%, in each instance based on the total weight of the phenols used.

The general terms “aldehyde” and “one or more aldehydes” include, in addition to formaldehyde, polymers of formaldehyde such as paraformaldehyde or polyoxymethylene, acetaldehyde, additional aliphatic or aromatic, monohydric or polyhydric, saturated or unsaturated aldehydes such as butyraldehyde, benzaldehyde, salicylaldehyde, furfural, acrolein, crotonaldehyde, glyoxal, or mixtures of these. Especially suitable aldehydes include formaldehyde, metaldehyde, paraldehyde, acetaldehyde, and benzaldehyde. Formaldehyde is particularly suitable, is economical, and is readily available. Equivalents of formaldehyde for purposes of the present invention include paraformaldehyde, as well as hexamethylenetetramine which, when used according to the invention, also provides a source of ammonia. These and other suitable aldehydes are described in U.S. Pat. No. 3,960,761, the relevant portion of which is incorporated herein by reference.

When formaldehyde is used as an aldehyde, it may be added as a 37% solution of para-formaldehyde in water and alcohol, called formalin. The alcohol is usually methanol, and is typically present in such solutions at a concentration average of approximately 7-11% based on the formaldehyde sample. The methanol is a good solvent for the para-formaldehyde and acts to keep the para-formaldehyde from precipitating from solution. The formalin can thus be stored and processed at low temperatures (<23° C.) without para-formaldehyde precipitating from solution. However, as further described below, we have found that much less methanol can be used to deliver formaldehyde to the reaction than is typically used, and that solutions having less methanol provide certain advantages. Thus, one aspect of the invention relates to processes of producing resol beads in which the amount of methanol is limited.

In one aspect, the aldehyde used is one or more alkyl aldehydes having from one to three carbon atoms and present in an amount of at least 50%, with respect to the total weight of the aldehydes used, or at least 60%, or at least 75%, or at least 90%, or even at least 95%, in each instance based on the total weight of the aldehydes used.

In another aspect, the aldehyde used is formaldehyde, for example present in an amount of at least 50%, with respect to the total weight of the aldehydes used, or at least 60%, or at least 75%, or at least 90%, or even at least 95%, in each instance based on the total weight of the aldehydes used.

The methods according to the invention are carried out in the presence of an effective-variable concentration of a nitrogen-containing base as catalyst, such that the aqueous reaction medium is typically a basic aqueous medium, that is, an alkaline medium, having a pH, for example, greater than 7, or at least 7.5, or at least 8, up to about 11, or up to about 12, or from about 7 to about 12, or from 7.5 to 11. However, the pH may change during the course of the reaction, such that the pH values may be those obtained at the start of the processes by which the resol beads of the invention are obtained.

A variety of nitrogen-containing bases may be used as catalysts, including but not limited to ammonia or ammonium hydroxide; and amines such as ethylene diamine, diethylene triamine, hexamethylenediamine, hexamethylenetetramine, or polyethylenimine. It is understood that the various nitrogen-containing bases used may exist in an aqueous medium as hydroxides, in whole or in part, for example ammonia or ammonium hydroxide. Further, when a source of nitrogen-containing base such as hexamethylenetetramine is provided, the molar amount of nitrogen-containing base provided by the molecule to the reaction mixture is used to calculate the molar concentration of nitrogen-containing base. For example, because hexamethylenetetramine provides four ammonia molecules to the reaction mixture upon dissociation, only one-quarter the molar amount of hexamethylenetetramine is required to provide the desired concentration in moles of ammonia.

Thus, in one aspect, the concentration of nitrogen-containing base in the reaction mixture may be at least 0.25 mol/kg, or at least 0.3 mol/kg, or at least 0.35 mol/kg, or at least 0.4 mol/kg, or at least 0.5 mol/kg. In another aspect, the concentration of nitrogen-containing base in the reaction mixture may be up to about 0.6 mol/kg, or up to 0.65 mol/kg, or up to 0.7 mol/kg, or up to 0.75 mol/kg, or up to 0.8 mol/kg.

In another aspect, the concentration of nitrogen-containing base in the reaction mixture may be expressed as a molar ratio with respect to the moles of phenol, in which the molar ratio may be at least 0.08, or at least 0.1, or at least 0.12, or at least 0.15, in each case with respect to the molar amount of the phenol, up to about 0.18, or up to 0.20, or up to 0.22, or up to 0.25, the ratio in each case being the molar ratio of the nitrogen-containing base to the phenol in the reaction mixture.

The methods according to the invention are carried out in the presence of an effective-variable concentration of a nitrogen-containing base as catalyst. The inventive correlation between the concentration of nitrogen-containing base in the reaction mixture and the mean particle size of the resulting resol beads, with and without the use of previously-formed resol beads as seeds, may be seen in the Tables of the Examples.

For resin syntheses carried out at similar agitation rates, we have found that higher concentrations of a nitrogen-containing base such as ammonia gave larger beads and higher yields. This correlation was true whether the resin synthesis was carried out as a total batch synthesis, or a fed batch (where the ammonia and formaldehyde solution was fed to the phenol and remaining reagents), and whether or not seeds were used. The range of ammonia concentrations most useful to produce the resol beads depended somewhat on the temperature and the amount of time of the synthesis. For example, when the synthesis was carried out at 75° C. over a 5 hour period, we found a minimum ammonia concentration of about 0.375 M to be effective. Lower concentrations tended to produce beads that were sticky and clumped together. At a reaction temperature of 85 or 90° C., ammonia concentrations as low as about 0.309 M could be used.

At the same agitation rate, the highest useful ammonia concentration to obtain beads having a suitable morphology would be something less than 0.882 M, since the use of ammonia at concentrations of 0.882 M or higher produced beads that were oblong and flat in shape. However, we believe that increasing the amount of agitation would result in beads having a suitable morphology.

As set out in the examples, a series of fed-batch and batch resin preparations were carried out using ammonia (as ammonium hydroxide) at concentrations of 0.309 M, 0.375 M, 0.441 M, 0.507 M, and 0.574 M. The agitation rate and the concentrations of the other reagents were the same in each run. In the fed-batch experiments, the ammonia was mixed with the formaldehyde solution and the resulting solution was fed to the phenol, surfactant, water, CMC mixture over a 90-min period at the reaction temperature indicated. In the batch experiments, all reactants were added at room temperature and the resulting mixture was heated to reaction temperature (careful to avoid overshooting the target temperature). All preparations were worked up the same way.

For both methods (fed-batch and batch), higher ammonia concentrations gave higher recoverable yields and larger size beads. The size of the beads was related to the yield in that larger beads are more easily isolated (fewer fines). The mean size of the particles recovered ranged from 68 μm (for 0.309 M ammonia) to 362 μm (for 0.662 M ammonia). As noted, an ammonia concentration of 0.882 M produced large beads that were mostly oblong or flattened in shape. The fed-batch preparations consistently gave higher yields of beads than the batch preparations with similar ammonia concentrations.

The relationship between bead size and ammonia concentration was also true when seeds were used. However, the ratio of the surface area of the seeds to the phenol was kept relatively low, i.e., around 10 or less. At a ratio of 33 m2/kg, no effect of ammonia concentration on bead size was observed. However, when the ratio was lowered to 9 m2/kg, the reactions using higher ammonia concentration produced larger beads. When the ratio was lowered to 7 m2/kg, the effect of ammonia concentration was even more pronounced.

In the examples in which previously-formed beads were used, resin syntheses were carried out using ammonia concentrations of 0.309 M, 0.375 M, 0.441 M, 0.507 M, and 0.574 M, and with 57 g of seeds having a mean particle size of 69 μm. The temperature profile in this series included 5 hours at 75° C., followed by 90° C. for 1 hour. The concentration of all other reagents was the same for all experiments. The ratio of seed surface area to phenol was 33 m2/kg as calculated assuming a uniform size distribution. The results of these preps are listed in Table 2. The mean size of the beads produced in each preparation was essentially the same, indicating that the ammonia concentration had no effect on the mean size of the product made using 57 g of seeds. However, the yield of product increased with increasing ammonia concentration. Particle size measurements indicated that fewer fine particles were produced at higher ammonia concentrations.

Similar experiments were carried out using only 15 g of the seeds (surface area/phenol=9) with ammonia concentrations of 0.574 M, 0.441 M, and 0.309 M. In these experiments, the temperature profile consisted of a 5 hour period at 75° C. In this series, the 0.574 M run gave a mean size of 144 μm and 0.441 M gave a mean size of 118 μm. The prep using 0.309 M produced a sticky and opaque product indicative of incomplete reaction. The latter reaction was repeated with fresh reagents and gave identical results. It was concluded that an ammonia concentration of 0.309 M was insufficient at the lower temperature. The results outlined above show that higher ammonia concentrations are beneficial even when seeds are used, as long as the surface area to phenol ratio is not too large.

In the methods and processes according to the invention, the amount of water in the aqueous medium is not particularly critical, although it will be most economical that the reaction not be carried out in a dilute aqueous medium. The amount of water used will be at least an amount that will permit the formation of a phenolic resin-in-water dispersion, typically at least about 50 parts by weight of water per 100 parts by weight of the resol beads obtained. There is no advantage to using a large amount of water, and in fact, the reaction will likely proceed more slowly when excess water is used, although the invention will work even with a large excess of water. Typical levels of water with respect to the organic reactants will thus typically be from about 30 to about 70 wt %, or from 50 wt % to 70 wt %. Thus, the amount of water may vary within a relatively wide range, for example from about 25 to about 95 wt. %, or from 30 to 80 wt. %, or from 35 to 75 wt. %.

The colloidal stabilizers useful according to the invention serve to promote or maintain a phenolic resin-in-water dispersion such that resol beads are formed in the aqueous medium during the course of the reaction. A wide variety of such agents may be used including, without limitation, naturally-derived gums such as gum arabic, gum ghatti, algin gum, locust bean gum, guar gum, or hydroxyalkyl guar gum; cellulosics such as carboxy-methylcellulose, hydroxyethyl cellulose, their sodium salts, and the like; partially hydrolyzed polyvinyl alcohol; soluble starch; agar; polyoxyethylenated alkylphenols; polyoxyethylenated straight-chain and branched-chain alcohols; long-chain alkyl aryl compounds; long-chain perfluoroalkyl compounds; high molecular weight propylene oxide polymers; polysiloxane polymers; and the like. These and other agents are further described, for example, in U.S. Pat. No. 4,206,095, the relevant portion of which is incorporated herein by reference.

The colloidal stabilizers are used in amounts sufficient to promote the formation or stabilization of a phenolic resin-in-water dispersion as the resol beads are formed. They may be added at the start of the reaction, or may be added after some initial polymerization has taken place. It is sufficient that the dispersion be stable while the reaction mixture is being agitated, the agitation thus assisting the colloidal stabilizers in maintaining the desired dispersion.

It is typical to use the colloidal stabilizers in relatively small amounts, for example from about 0.05 to about 2 weight percent, or from 0.1 to 1.5 weight percent, in each case based on the weight of phenol. Alternatively, the colloidal stabilizers may be used in amounts up to 2 weight percent, or up to 3 weight percent or more, based on the weight of phenol. Typically from about 0.2 weight percent to about 1 weight percent, based on weight of phenol, is a good starting point for developing suitable formulations.

A variety of carboxymethylcelluloses may be used according to the invention as colloidal stabilizers, having a variety of degrees of substitution, for example, at least 0.4, or at least 0.5, or at least 0.6, up to about 1.2, or up to about 1.5, or from about 0.4 to about 1.5, or from 0.6 to 1.2, or from 0.8 to 1.1. Similarly, the molecular weight of the carbyoxymethylcellulose may also vary, for example from about 100,000 to about 750,000, or from 150,000 to 500,000, or a typical average of about 250,000.

We have found carboxymethylcellulose sodium to be especially well-suited for use according to the invention.

We have found that products made using certain guar gums resulted in particles that were often rough textured and contained large amounts of fused beads or agglomerates.

The methods and processes according to the invention may optionally be carried out in the presence of one or more surface active agents, hereinafter surfactants, and indeed in the absence of seed particles, it may be helpful to provide a surfactant in order to obtain desired properties in the resol beads formed.

Surfactants useful according to the invention include anionic surfactants, cationic surfactants, and nonionic surfactants. Examples of anionic surfactants include, but are not limited to, carboxylates, phosphates, sulfonates, sulfates, sulfoacetates, and free acids of these salts, and the like. Cationic surfactants include salts of long chain amines, diamines and polyamines, quaternary ammonium salts, polyoxyethylenated long-chain amines, long-chain alkyl pyridinium salts, lanolin quaternary salts, and the like. Non-ionic surfactants include long-chain alkyl amine oxides, polyoxyethylenated alkylphenols, polyoxyethylenated straight-chain and branched-chain alcohols, alkoxylated lanolin waxes, polyethylene glycol monoethers, dodecylhexaoxylene glycol monoethers, and the like.

We have found sodium dodecylsulfate (SDS) to be well-suited for use according to the invention.

Other anionic surfactants are also well-suited for use in the invention, and although the surfactant may be omitted and acceptable product having a relatively narrow size distribution obtained, the presence of a surfactant appears to aid the formation of a more spherical product.

In the methods and processes according to the invention by which the resol beads are prepared, the reaction is carried out in an agitated aqueous medium, the agitation provided being sufficient to provide a phenolic resin-in-water dispersion such that resol beads are obtained having a desired particle size. The agitation may be provided in a reaction vessel by a variety of methods, including but not limited to pitched blade impellers, high efficiency impellers, turbines, anchor, and spiral type agitators. The reaction mixture may be agitated at a relatively slow rate, which is dependant in part upon the size of the vessel, with, for example, an anchor-shaped stirring paddle. Alternatively, the agitation may be provided, for example, by the mixing caused by flow induced by internal or external circulation, by cocurrent flow or counter-current flow, for example with respect to a flow of reactants, or by flowing the reaction medium past one or more stationary mixing devices, such as static mixers.

The present invention may be understood more readily by reference to the following detailed description of the methodology and to the examples provided. It is to be understood that this invention is not limited to the specific processes and conditions described, because specific processes and process conditions for processing articles according to the invention may vary. It is also to be understood that the terminology used is for the purpose of describing particular embodiments only and is not intended to be limiting.

An advantage of the present invention, as described herein, is the ability to obtain a desired particle size and particle size distribution. The particle size distribution of resol beads obtained according to the invention, as defined herein, may be that measured following the isolation techniques described below.

After the reactions are completed and resol beads obtained, the resol beads of useful size are obtained by cooling the product mixture to a temperature from about 20° C. to about 40° C., and the slurry is drained from the reactor into a transfer vessel having an agitation device so that solids may be suspended in the vessel when desired. The contents of the vessel are first allowed to stand for a period from about 15 to about 60 minutes (without agitation) to allow a bed of particles to form at the base of the vessel. A clear separation between the lower bed of particles and the upper liquid phase will be visible when the settling process has been completed. Typically, the liquid has a milky appearance and has a viscosity in the range from 0.10 to 20 cP. The presence of a large number of sub-5 micron particles gives the liquid phase this milky appearance.

From the settled slurry suspension, the liquid phase is decanted from the top of the vessel until the separation line between the settled bed of particles has been reached. This decantation process will remove the majority of the liquid in the vessel. The quantity remaining in the bed of particles will be from about 5% to about 30% of the total amount of liquid originally present in the slurry. Contained in the decanted liquid phase are a large quantity of sub-5 micron particles that are still suspended in the liquid phase that will be removed from the vessel. This quantity of suspended solids represents from about 0.10% to about 5% of the total yield of solids from the process.

To the bed of solids, an amount of water is added that is approximately equivalent to the amount of decanted liquid removed from the vessel. The contents of the vessel are then re-suspended using an agitation device such that the concentration of the solid phase is homogeneous throughout the vessel. The mixing is typically continued for at least 10 minutes.

The impeller is then switched off and the slurry is allowed to settle once again to form a bed of solids at the base of the vessel. The slurry is allowed to settle for about 15 to about 60 minutes until a discrete interface between the bed of solids and the liquid can be seen.

The procedure for washing the solids described above is repeated a further 2 to 4 times until the liquid phase is substantially clear and free of any suspended solids.

The slurry is then re-suspended, using the agitator, and the contents of the vessel are poured onto a filter. Once the slurry has been poured on to the filter, vacuum is applied to the bed of solids to separate the liquid phase from the solid phase. The vacuum is maintained until the liquid has been removed from the cake. The time needed to do this will depend on the resistance offered by the bed of solids and the filtration medium. Typically, for particle sizes in the range 100 to 700 μm and a filter element having an average pore size of 40 μm, this process will take from about 5 to about 60 minutes.

After liquid has been removed from the cake, nitrogen gas at room temperature and pressure is fed to the top of the cake. The gas is drawn through the cake using the vacuum located at the base of the bed. The gas is drawn through the cake for from 1 to 12 hours, until the bed of solids has been dried. The moisture content of the cake should be below 1% on a total solids basis. The dry solids are removed from the filter.

The particle size distribution of the dry solids can be determined by a number of methods. For example, a selection of sieves may be used to fractionate the solids into separate groups. For example, for a distribution containing particles in the size range from 50 to 650 um, the initial sieve fraction could be between 50 and 150 um. The second could be between 150 and 250 um, and so on in 100 um increments up to 650 um. Alternatively, sieve fractions could be selected to yield fractions of 50 μm instead of 100 μm.

By fractionating the solids into different fractions, a particle size distribution can be generated that expresses the fraction (volume or weight) of the distribution present at the median size of each sieve fraction. In the sieving procedure, sufficient time should be given to allow the mass of particles in each fraction to reach a steady-state mass. For this a time from about 1 to about 24 hours are typically required, or sufficient time such that the mass on each sieve screen reaches 99% of it's final steady state value, or until the mass on each screen does not change by more than 0.10% of the mass on that sieve fraction over a period of 5 hours, for example.

Another method of measuring the particle size distribution is to use a forward laser light scattering device. Such a device can yield a volume fraction distribution of particles as a function of particle size. The device operates by passing a sample of particles suspended in a non-absorbing liquid medium into the path of a laser beam. A particle modifies the laser light which falls upon it by the two basic mechanisms of scattering and absorption. Light scattering includes diffraction of the light around the edges of the particle surface, reflection from the particle surface, and refraction through the particle. The result of refraction of the light through the particle results in a distribution of scattered light in all directions.

The scattered light is focused on to a photodiode detector array that is located at a distance from the measurement plane. The detector is comprised of an array of discrete photodiodes arranged in semi-circular fashion. The diffraction angle of the incident light is inversely proportional to the size of the particle that diffracts the light. Therefore, the outermost diodes collect signals from the smallest detectable particles and the innermost diodes collect signals from the largest detectable sizes. From an understanding of the theory of light scattering and a knowledge of the system geometry, a particle size distribution can be re-constructed from the diffraction pattern in terms of the number of volume distribution. An example of a device useful for such measurements is the Malvern Mastersizer 2000 that measures in the size range 0.20 to 2000 microns and is sold by Malvern Instruments Ltd. (Malvern, UK). Another such instrument is the Beckman Coulter LS 230 that can measure in the 0.02 to 2000 micron range and is sold by Beckman Coulter Inc. (Fullerton, Calif., USA). Both instruments operate on the above principal and are sold with accompanying proprietary software.

From the distribution determined from either of the above techniques, certain characteristic sizes of the distribution can be calculated. Characteristic sizes are used to compare distributions of particles from different experiments to determine the effect of the processing conditions on the size distribution of particles produced. For example, the 10% characteristic size (d₁₀) of a distribution can be determined. The d₁₀ characteristic size represents a particle size in which 10% of the volume of all particles is composed of particles smaller than the stated d₁₀ and conversely, it is the size in which 90% of the volume of all particles is composed of particles larger than the stated d₁₀. Similarly, the d₉₀ characteristic size represents a particle size in which 90% of the volume of all particles is composed of particles smaller than the stated d₉₀ and conversely, it is the size in which 10% of the volume of all particles is composed of particles larger than the stated d₉₀. Similarly, the 50% size (d₅₀) is the size below and above which 50% of the volume of all solids from the batch lies. The d₅₀ is also termed the median size.

To represent the particle size distribution determined from a sieving procedure, the median size of a sieve fraction is determined. The particle size distribution determined from a sieving technique is a mass based distribution, which for a system with uniform density is equivalent to a volume based distribution. The median size (d₅₀) of the distribution is the size above and below which lay 50% of the volume of particles (V₅₀).

The diameter of the largest particle in a sieve fraction is the diameter of the screen opening in the upper sieve fraction (dᵤₚₚₑᵣ) and the diameter of the smallest particle in a sieve fraction is the diameter of the screen opening in the lower sieve fraction (d_{lower}). The volume of the smallest particles in a sieve fraction can thus be calculated from the following general formula:

$${V}_{lower} = \frac{π}{6} {d}_{lower}^{3} .$$

The median size of a sieve fraction is obtained from the following formula that expresses the volume above and below which 50% of the volume in the sieve fraction lays,

$${V}_{50} = \frac{{V}_{upper} + {V}_{lower}}{2} .$$

Canceling terms in the above equation, the following formula for sieve median size can be derived,

$${d}_{50} = \sqrt{\frac{{d}_{upper}^{3} + {d}_{lower}^{3}}{2}} .$$

For the examples described in the present application, the median sieve size is used when plotting the mass distribution of particles as a function of size.

To calculate the d₁₀ or the d₉₀ of a distribution, a cumulative graph of the distribution is plotted with the median sieve size of each sieve fraction on the x-axis and the cumulative mass fraction on the y-axis. The d₁₀ or the d₉₀ sizes can be read off the graph by reading the size that corresponds to 10% and 90% of the cumulative total of mass or volume fraction on the graph.

For a particle size distribution measured by laser light scattering, a similar procedure is used to determine the d₁₀ or the d₉₀ sizes. The cumulative mass or volume fraction is plotted against the reported size and the size that corresponds to 10% and 90% of the cumulative total of mass or volume fraction on the graph can be read.

Particle size distribution, as used herein to define resol bead size distribution or activated carbon bead size distribution, may be expressed by as a “span (S),” where S is calculated by the following equation:

S=d₉₀−d₁₀

where d₉₀ represents a particle size in which 90% of the volume is composed of particles smaller than the stated d₉₀; and d₁₀ represents a particle size in which 10% of the volume is composed of particles smaller than the stated d₁₀; and d₅₀ represents a particle size in which 50% of the volume is composed of particles larger than the stated d₅₀ value, and 50% of the volume is composed of particles smaller than the stated d₅₀ value.

A range of particle size distributions may be obtained according to the invention following the isolation techniques just described. For example, span values from about 25 microns to about 750 microns may be achieved, or from about 50 to about 500 microns, or from about 75 microns to about 375 microns, the span being defined above as the d₉₀ particle size minus the d₁₀ particle size. Typical d₅₀ particle size values for the spans just described might be from about 10 um to about 2 mm or more, or from 50 microns to 1 mm, or from 100 microns to 750 microns, or from 250 microns to 650 microns.

Alternatively, span values from 100 to 225 microns may be achieved in which greater than 20% of the weight of the distribution is in the size range greater than 425 microns. In a further alternative, a span from 100 to 160 microns in which at least 50% of the weight of the distribution, or at least 65% by weight, or at least 75% by weight are present as particles greater than 425 microns may be achieved following the isolation techniques described.

In one embodiment, the resol beads according to the invention may be prepared, for example, by reacting in an agitated aqueous medium a phenol and an aldehyde, in the presence of a base such as ammonium hydroxide provided as a catalyst, a colloidal stabilizer such as carboxymethylcellulose sodium (for example having a degree of substitution of about 0.9), and optionally a surfactant such as sodium dodecylsulfate.

The processes described herein will be generally carried out for a period of time and at a temperature sufficient to produce an aqueous dispersion of resol beads.

Thus, the reaction may be carried out, for example, at a temperature from about 50° C. to about 100° C., or from 60° C. to 950, or from 75° C. to 90° C.

Similarly, the length of time the reaction is allowed to run may vary based on temperature, for example, from about 1 hour, or less, up to about 10 hours, or more, or from 1 hour to 10 hours, or from 1 hour to 8 hours, or from 2 hours to 5 hours. In certain embodiments, we have held the reaction mixture at a temperature of about 70° C. for about 5 hours, and then raised the temperature to about 90° C. for about 1 hour. Alternatively, we have held the reaction mixture at a temperature of about 85° C. for about 4 hours, and then raised the temperature to about 90° C. for about 30 minutes to 1 hour. Another alternative would be to hold the reaction mixture at a temperature of about 85° C. for about 2 hours, and then to raise the temperature to about 90° C. for about 1 hour. The use of substituted phenols may require higher reaction temperatures than when using phenol, that is, monohydroxybenzene.

The processes according to the invention will typically be carried out at temperatures such as those already described, and at pressures at which emulsion polymerizations are typically carried out. It may be advantageous in some instances that the reaction pressure be maintained at pressures greater than 1 atmosphere, in order to obtain beads having a density greater than that obtained at lower reaction pressures. This is because, if pockets of gaseous byproducts are trapped within the beads, it is reasonable to expect that higher reaction pressures would decrease the volume of the gaseous pockets and result in a denser product.

In various aspects, the particle sizes of the resol beads prepared according to the invention may vary within a wide range as measured using the measurement techniques already described, for example having a median particle size, or d₅₀, of from 10 μm up to 2 mm, or up to 3 mm, or more, especially in those cases in which beads are recycled, the beads typically growing at a rate of up to about 200 microns per pass. Alternatively, the median particle size may fall within the range from 25 μm to 1,500 μm, or from 50 μm to 1,000 μm, or from 100 μm to 750 μm, or from 250 μm to 500 μm. With the median particle sizes just described, the span might be, for example, from 25 microns to 750 microns, or from 50 to 500 microns, or from 75 microns to 375 microns, or from 75 microns to 200 microns, or as already described. The beads may alternatively grow at a rate from about 25 microns to about 250 microns, or from 50 microns to 200 microns, or from 100 microns to 200 microns, in each case per pass through a reaction medium.

A range of particle sizes and particle size distributions may be achieved according to the invention, and we have found that the use of previously-formed resol beads as seed particles allows more control of these variables than prior art processes, and that the amount of nitrogen-containing base provided to the reaction mixture will affect the particle size and yield.

Thus, in one aspect, the resol beads made according to the invention may have a relatively large particle size, and a relatively narrow particle size distribution, when compared to what has heretofore been achieved, as already described.

When previously-formed resol beads are used as seed particles, the size of the previously-formed resol beads used can vary within a wide range or given size fraction, and will be selected based on the sizes or fractions available, as well as on the desired particle size and particle size distribution of the final resol beads. Thus, the median particle size or d₅₀, of the previously-formed resol beads may be, for example, at least about 1 μm, or at least 10 μm, or at least 50 μm, up to about 500 μm, or up to 1 mm, or up to 1.5 mm, or even up to 2 mm or greater. Alternatively, the median particle size of the previously formed beads may be in the range from about 1 μm to about 2 mm, or from 10 μm to 1,500 μm, or from 50 μm to 1,000 μm, or from 100 μm to 750 μm, or from 125 μm to 300 μm. The suitable particle size for the previously-formed resol beads will be selected based on the desired particle size of the finished particle, and based on the amount of nitrogen-containing base provided to the reaction mixture.

Similarly, previously-formed resol beads having a range of particle size distributions are useful according to the invention, the distribution selected being based in part on the size fractions available, the need for a relatively uniform particle size in the resol beads obtained, and the avoidance of waste by using beads having a range of particle size distributions. Thus, previously-formed resol beads having span values from about 25 microns to about 750 microns may be used, or from about 50 to about 500 microns, or from about 75 microns to about 250 microns, the span being defined above as the difference between the d₉₀ particle size and the d₁₀ particle size.

In practice, in those embodiments in which previously formed beads are to be provided to subsequent reaction mixtures and in which an average particle size from about 300 μm to about 425 μm is desired, the beads may be formed as described elsewhere herein, and then dried and sieved into fractions, for example four fractions: those greater than about 425 μm (>425-μm); those from about 300 μm to about 425 μm (>300<425-μm); those from about 150 μm to about 300 μm (>150<300-μm); and those less than about 150 μm (<150-μm). By this means, the material<300-μm may be recycled to a subsequent batch. In the subsequent batch, the material>300-μm may thereby be substantially increased, resulting in a narrower size distribution. Without wishing to be bound by any theory, it appears that the smaller beads that are recycled to the reaction grow in size, thus increasing the yield of product in the 300-425 μm size range. By means of the use of the previously formed beads, a total yield of material in the 300-425 μm size range over 5 batches may be achieved that is similar to the total yield of product minus the yield of material<300-μm initially produced.

We have found that the final average bead size is dependent in part upon the size of the previously-formed resol beads used as recycled seed. Thus, the processes according to the invention provide the flexibility of tailoring the desired bead size by varying the size of the recycled seed that is used. For example, we found that use of seeds smaller than 150 micron results in increasing the yield of 150-350 micron product, while 150-300 micron seeds will increase the yield of beads greater than 425 microns. We have found also that the reactivity of the seeds is affected if the bead is allowed to cure. It may therefore be helpful to avoid curing or only partially curing, for example by heating, seeds that are to be recycled. We found that when the seeds to be recycled are cured in a separate step at elevated temperature, they did not appear to grow in size during the reaction as much as did uncured seeds.

When preparing the resol beads according to the invention, the average size of the beads may vary as a function of the agitation rate and the type of agitator used during the reaction, as well as the amount of nitrogen-containing base provided. In general, rapid agitation results in smaller bead size while slow agitation results in larger beads. Slow agitation rates using a conventional pitched turbine blade or crescent blade may result in nucleation on the walls of reactor due to poor movement, leading to undesirable amounts of cake formation and excessive build up on reactor walls. This problem may be avoided by using an anchor-type agitator which, even at slow speeds, will sweep reactor walls during the reaction.

However, while the agitation rate provides some control over the average size of the beads, it typically does not provide as much control over the particle size distribution. Previously-formed resol beads therefore may be used according to the invention, in addition to the amount of nitrogen-containing base provided to the reaction mixture, in order to provide a measure of control over the particle size and particle size distribution.

A variety of particle sizes and particle size distributions may be achieved according to the invention as the previously-formed resol beads, as already described, and the size and size distribution may be selected so as to achieve the desired particle size and particle size distribution in the final product resol beads in light of the present disclosure.

Although seeds having a variety of particle sizes and particle size distributions may be used according to the invention, we have found that in some applications, the amount of recycled beads may be selected as a function of the ratio of the external surface area of the recycled beads to the amount of phenol used in the reaction.

The external surface area of the seeds was calculated using the average diameter of the seeds charged. For example, for a monodisperse distribution of particles wherein the maximum diameter of any particle is “d”, the maximum cross-sectional area (Area) of the particle taken across the meridian plane of the particle can be calculated from the following formula:

Area=πd² (m²)

The formula above calculates the surface of a single particle having a size of d. For example, if the value of d was 250 microns, the surface area would then be calculated as:

A_{Particle}=π(250.10⁻⁰⁶)²=1.964.*10⁻⁰⁷m²

We have found that, should it be desirable to avoid formation of an excessive amount of small particles (fines), the total surface area of the recycled beads provided (in m²) may desirably be, for example, at least five times greater than, or at least six times greater than, or at least seven or eight times greater than the amount of phenol (in kg).

We have found that, if the ratio is less than about eight, for example, there is substantially more nucleation of new particles than growth of existing particles. The number ratio of new particles generated during the reaction (from nucleation) is plotted against the surface area of recycled beads charged to the reaction per unit mass of phenol charged. When the surface area of the seeds is less than about 5 m² per kg of phenol, the number of new particles may increase dramatically. These new particles will be mainly small and present in the product as undesirable, fine powder.

Thus, if it is desirable to ensure that the growth of the initial seeds is promoted in the vessel and nucleation of fines particulates is suppressed, sufficient seeds of the appropriate size may be charged to the reactor such that the surface area (in m²) of the seeds added to the reaction is at least 5 times the amount of phenol added to the vessel (in kg). These two measures: seeding with the desired particle size, and providing sufficient surface area, may yield a product having a larger proportion of product in a desired size range.

The temperature history of the previously formed beads used as seeds may be significant, in order to ensure that the surfaces of the beads remain active.

For example, a limited curing step implemented at the end of each batch reaction at a temperature of about 90° C. for 45 minutes will typically be sufficient when the beads are to be recycled. We found that if treated in water at a temperature of 100° C., the surfaces of the beads were apparently deactivated, making it difficult for them to function as seeds to grow larger beads.

Thus, in one aspect, the resol beads according to the invention may have a relatively large particle size, and a relatively narrow particle size distribution, when compared to what has heretofore been achieved.

For example, when particles having a size range from about 425 to about 600 um are desired, particles smaller than 425 um may be considered suitable for use as seeds to be recycled for successive batches, along with proper selection of the amount of nitrogen-containing base provided. However, particles in the size range of 150 to 300 um may be more desirable for use as seeds, as they may give a product yield of from 60 to 80% in the desired size range (425 to 600 um) during a given batch. The other 20 to 40% of the yield is present as over (>600 um) or undersize (<425 um) beads. We expect that some of the undersized beads are formed as a result of nucleation that has occurred during the batch, and that some of the undersized beads are the original seeds that have not grown to sizes exceeding 425 um. The oversized beads are probably the result of the seed particles growing to sizes larger than 600 um. Thus, the amount of under or oversized beads produced may be a function of several factors such as the nucleation rate, the activity of the beads, and the yield of the process, in addition to the amount of nitrogen-containing base provided.

When relatively large particles are desired, and a relatively small amount of nitrogen-containing base is provided, particles in the 1 to 150 um size ranges might well be considered too fine to use as seeds. They result in a small yield of product-sized particles. Particles in the 300 to 425 um size range are also considered less suitable, as they will typically produce particles larger than 600 um and do not give the required yield of product.

Because a relatively wide distribution of particles is produced from each batch, it may not be practical to select an extremely narrow distribution as seed particles and still have enough material in the 150 to 300 um size class to act as seed. For this reason, a distribution of seeds is typically chosen to seed each batch.

Thus, in practice, a quantity of relatively mono-disperse seeds may be added to each reaction batch to act as sites for growth of a phenolic resin bead. The surface area of the seeds may be used to determine a suitable quantity of seed to be used. For example, for each kg of phenol charged to the batch reactor, the surface area of the seeds (in m²) may be, for example, at least 5 times the weight of phenol (in kg) charged to the reactor, or at least 6 times the weight, or at least 7 times the weight of phenol used, calculated as already described.

When previously-formed resol beads are used as seeds to prepare the resol beads in a method of the invention, the following steps may be used, for example, to produce the resol beads:
a) Charging to a reaction mixture all or a part of a phenol, an aldehyde such as formaldehyde, and a base such as ammonia (for example as ammonium hydroxide or hexamethylenetetramine) to an agitated aqueous medium containing a colloidal stabilizer and optionally a surfactant.
b) Charging a quantity of previously-formed resol beads to the reaction mixture having surface functionality reactive with one or more of the phenol or formaldehyde monomers. The quantity of seeds used may be sufficient, for example, to provide a surface exceeding 5 m² per kg of phenol added.
c) Heating the reaction mixture to a temperature from about 75° to about 85° C. and adding any remaining reactants (phenol, formaldehyde, ammonia) to the vessel in semi-batch mode during the course of the reaction.
d) Holding the reaction mixture at this temperature for about 5 hours or more.
e) Heating the reaction mixture to about 90° C. for about 45 minutes.
f) Cooling the reaction mixture to between about 10° C. to about 50° C. and separating the resulting resol beads from the liquid in the reaction mixture.

Alternative times and temperatures may be used as described elsewhere herein.

Typically, with each pass through the process, whether a particle is present that originates from a previously-formed bead provided or from a resol particle source, more reaction product is deposited on the surface. Thus, a particle increases in size each time it passes through the process. We have found that during a typical reaction conducted according to the invention, a particle size may increase, for example, by about 100 to 200 μm, or as already described.

The processes according to the invention may be carried out batch-wise, in which all of the reactants are provided to the reaction mixture together. Alternatively, the processes may be carried out using various semi-batch additions as further described herein.

Without wishing to be bound to any particular theory, the following discussion sets out the mechanism by which the resol beads appear to form.

The condensation reaction of an aldehyde such as formaldehyde with a phenol in the presence of a nitrogen-containing base as catalyst in an agitated aqueous environment at elevated temperatures, for example at least 60° C., leads to the formation of a two-phase mixture, the aqueous phase containing unreacted formaldehyde, phenol, ammonia and lower order alcohols, the second phase containing higher order, non-crosslinked polymeric species formed as a result of the resol condensation reaction. The resol compounds oil-out from solution due to their high molecular weight. By using a colloidal stabilizer, the oil phase forms beads of polymeric material that are suspended in the stirred vessel as discrete droplets. Over the course of time, the cross-linking action of formaldehyde diffusing into the liquid droplets causes a further increase in the molecular weight of the polymer. The increase in molecular weight leads to the solidification of the oil droplets to form resol beads that can be filtered, washed and recovered for use as a dry polymeric material.

The colloidal stabilizer and the optional surfactant may be present in the reaction mixture from the start of the phenol/aldehyde condensation, or else the condensation reaction may be conducted to the stage that a low viscosity resin is produced, and the colloidal stabilizer and surfactant added thereafter, with more water if needed. Sufficient water will typically be provided such that a phase inversion takes place, yielding a resin-in-water dispersion, with water being the continuous phase. The resol solids concentrations may vary within a wide range, since the amount of water is not critical, with a typical solids content up to about 40 or 50 weight percent, based on the weight retained in the solids upon drying.

A suitable dispersion of the resin in water during the early stages of the process is achieved by applying agitation to the aqueous medium, the use of an agitator being a convenient way to provide the needed agitation in batch and semi-continuous processes, and such devices as in-line mixer devices being suitable for continuous processes.

The resol beads formed are substantially water-insoluble, the resins typically having a weight average molecular weight of at least about 300, or at least 400, or at least 500, up to about 2,000, or up to 2,500, or up to 3,000 or more. Of course, it may be difficult as a practical matter to determine molecular weight when a significant amount of cross-linking has taken place.

Depending upon the intended end-use, it may be desirable to subject the resol to elevated temperature for a controlled period of time, optionally with an intervening neutralization step.

While we have found that batch processes result in serviceable beads, we have found that, in some cases, various semi-batch additions of reactants may result in a higher yield of the desired particle size and particle size distribution. Alternatively, continuous processes may provide certain advantages such as increased throughput and uniformity of product obtained.

According to further aspects of the invention, several semi-batch and staged modes of operation may be used, for example, in order to improve the yield or the particle size distribution obtained, such as to increase the amount of desired particles (>425 um) or to decrease the number of undesired fines particles (<150 um) made during the resol reaction.

By way of example, the following strategies may be used, in addition to proper selection of the amount of nitrogen-containing base, to yield advantages either in the yield of product or the quality of product (size), or both:

(i) Instead of adding all of the reactants to the reactor in batch mode, some or all of the phenol, surfactant, colloidal stabilizer, seed particles, and only a portion of the base and aldehyde may be added to the reactor at the start of the reaction, and the remaining aldehyde and base added in semi-batch mode over a period, for example, of 45 minutes. This strategy may minimize fines generation and maximize the distribution median size as measured by sieving the dried product.

(ii) In processes similar to those above in (i), the reactions may be conducted in stages. In such processes, perhaps a quarter of all the reactants are charged to the reactor with about half of the aldehyde and base being added in semi-batch mode. The reaction is allowed to proceed for 2 hours, before perhaps a further quarter of the ingredients are added to the reactor in the same manner as the first charge to the vessel with half of the aldehyde and base being added in semi-batch mode. The remaining two charges of materials may be added at further 2-hour intervals to the reactor in the same way. Seed particles are added during the first charge, the quantity added corresponding to the amount of phenol added in the first quarter charge, as already described. This type of strategy represents a staging of the process in order to grow a smaller amount of seeds to a larger size, and would be useful, for example, when only a small amount of seeds is available for use.

(iii) In further embodiments, similar to those described in (i) above, a further charge of a base, such as ammonia, is made, for example at about 2 hours after all of the initial base has been added to the vessel. The base is added to the vessel in semi-batch mode and the quantity used may be approximately the same as was originally charged to the reactor.

Thus, in one aspect, the invention relates to methods or processes for producing resol beads, the processes including a step of providing a phenol, a portion of an aldehyde, and a portion of a nitrogen-containing base as catalyst to a reaction mixture which is an agitated aqueous medium that includes a colloidal stabilizer, optionally a surfactant, and previously-formed resol beads; reacting for a period of time and at a temperature sufficient to produce an aqueous dispersion of resol beads; and thereafter adding a remaining portion of the base and the aldehyde over a period of time, such as about 45 minutes. The previously-formed resol beads may be obtained, for example, as under-sized resol beads produced in a previous batch, or in the case of a continuous or semi-continuous process, as recycled beads obtained at any earlier point in the process.

In yet another aspect, the invention relates to methods or processes for producing resol beads, the processes including a step of providing a portion of a phenol, a portion of an aldehyde, and a portion of a nitrogen-containing base as catalyst to a reaction mixture which is an agitated aqueous medium that includes a colloidal stabilizer, optionally a surfactant, and previously-formed resol beads; reacting for a period of time and at a temperature sufficient to produce an aqueous dispersion of resol beads, for example up to about two hours; thereafter a further portion of the phenol, a further portion of the aldehyde, and a further portion of a base as catalyst are added to the reaction mixture and reacted, for example for an additional two hours; and thereafter adding any remaining portion of the phenol, the aldehyde, and the base over a period of time and at a temperature sufficient to obtain the desired resol beads. The previously-formed resol beads may be obtained, for example, as under-sized resol beads produced in a previous batch, or in the case of a continuous or semi-continuous process, as recycled beads obtained at any earlier point in the process.

In yet another aspect, the processes of the invention may be carried out as already described, with a further portion of a base added after the reactants have begun reacting, or even when the reaction is otherwise substantially completed, the base being the same as or different from that already added to the reaction mixture as catalyst for the reaction.

It will be readily appreciated that any of the methods and processes described herein may be modified as already described, such as by charging only a portion of a phenol, an aldehyde such as formaldehyde, and a base such as ammonia (for example as ammonium hydroxide or hexamethylene-tetramine) to an agitated aqueous medium containing a colloidal stabilizer and optionally a surfactant; charging a quantity of seed particles, and after reacting for a time, adding any remaining portion of the phenol, formaldehyde, or ammonia to the vessel in semi-batch mode during the further course of the reaction.

In further aspects, the methods or processes by which the resol beads are formed may be continuous processes. Thus, in various aspects, continuous processes are envisaged according to any of the following.

A vessel containing an agitation device and operating at a temperature, for example, from about 75° C. to about 85° C., is provided with four continuous feed streams. In one stream, a mixture of phenol and water are fed to the vessel. The amount of phenol and water charged may comprise the total amount of these two compounds charged to the process. A second stream comprises a mixture of formaldehyde and ammonia. The amount of each corresponds to the amount of the phenol/water stream. The amount of formaldehyde and ammonia charged to the first reactor comprises from about 10% to 100% of the total amount of formaldehyde and ammonia charged to the process. The amount of ammonia and formaldehyde charged to the reactor may be independent of each other. A third feed stream comprises a colloidal agent such as soluble sodium carboxymethyl-cellulose, water, and optionally a surfactant such as sodium dodecylsulfate. A fourth feed stream comprises seed particles. The rate of the fourth stream may be such that the area rate (in m²/sec) being charged to the reactor is proportional to the mass rate of phenol being charged (in kg/s). The ratio of these two quantities may be, for example, equal to or greater than 4 m² of seed surface area per kg of phenol charged.

The streams just described are mixed in the reactor to facilitate growth of the resol particles. The residence time in this first reactor may be, for example, from about 1 hour to about 3 hours. The product from this reactor may then be fed to a second reactor also held at a temperature from about 75° C. to about 85° C. Any remaining formaldehyde and ammonia not charged in the first reactor is charged to this second reactor in continuous fashion. The residence time of the second reactor may be, for example, from about 1 to about 3 hours.

The product slurry from the second reactor may then be pumped to a third reactor operating at 90° C. No feed streams need be fed to this vessel. The residence time may be, for example, from about 30 minutes to about 2 hours. The product stream from the third reactor may then be pumped to a fourth reactor operating at 25° C. Sufficient residence time is provided in this vessel to cool all of the feed stream to below about 40° C. The product from this vessel is fed to a solid-liquid separation device in order to recover the solids fraction. A section of the solid-liquid separation may be used for washing of the solids fraction and another section used to dry the solids by using a hot gas stream to remove adhering moisture.

In a further embodiment, the reactants are added to a batch reactor to form an aqueous reaction mixture which is agitated. Approximately four-fifths of the formaldehyde and all the ammonia may be retained to be added at a later point in semi-batch mode. The batch reactor with the contents may then be heated to a temperature from about 75° C. to about 85° C. After the batch reactor reaches the operating temperature, the remaining formaldehyde solution and ammonia may then be added to the vessel in semi-batch mode for example over a period of 45 minutes or more. The mixture may be held at this temperature for 5 hours or more. The mixture is thereafter heated to about 90° C. for about 45 minutes. The mixture is thereafter cooled to a temperature from about 10° C. to about 50° C. and the solids separated from the liquid by filtration.

Further variations of the processes described include those in which two or more of the feed streams in a continuous process are combined prior to being added to the reaction medium. The mixing or agitation may be accomplished, for example, by a rotating agitator inside the vessel, by flow induced by external or internal circulation, by co-current or countercurrent flow provided in or to the reaction vessels, or by flowing the reaction medium past stationary mixing devices (static mixers). The number of the vessels may be varied from one to several vessels to vary the nature of the mixing from fully backmixed to approaching plug flow, limited by the practicality and economy of providing multiple vessels. Further, the temperatures of one or multiple vessels may be varied to adjust reaction rates or the slurry discharge temperature.

Alternatively, a continuous process may be used in which resol beads above a minimum particle size are recovered from the reaction medium, and resol beads below a minimum particle size are retained in or recycled to the reaction medium.

Thus, in yet another aspect, the methods of the invention may be carried out in processes for producing resol beads, the processes including:
a) reacting a phenol with an aldehyde in the presence of a nitrogen-containing base as catalyst, in an agitated aqueous medium that includes a colloidal stabilizer, and optionally a surfactant, for a period of time and at a temperature sufficient to produce an aqueous dispersion of resol beads;
b) recovering water-insoluble resol beads above a minimum particle size from the aqueous dispersion by any mean; and
c) retaining or recycling beads below the minimum particle size in or to the aqueous dispersion of resol beads.

In yet another aspect, the method of the invention may be caried out in processes for producing resol beads, the processes including:
a) reacting a phenol with an aldehyde in the presence of a nitrogen-containing base as catalyst, in an agitated aqueous medium that includes a colloidal stabilizer, and optionally a surfactant, for a period of time and at a temperature sufficient to produce an aqueous dispersion of resol beads;
b) recovering water-insoluble resol beads above a minimum particle size from the aqueous dispersion by any mean; and
c) retaining or recycling beads within a desired particle size range in or to the aqueous dispersion of resol beads.

Various configurations for solid-liquid separation from any of the above continuous processes, or recovery of beads above a minimum particle size, are possible, for example wherein the solids are fractionated according to size before being separated from the liquid of the reaction mixture. The fractionation may be accomplished by the use of devices integral to one of the vessels or in a separate device. Such size separation can be accomplished by various methods, such as by the use of a fixed physical aperture, such as a screen, slits or holes in a plate, whereby some solids pass and others are retained according to their ability to pass through the opening. Alternatively, gravity may be used, with or without countercurrent liquid flow, such as in a settling tank, or an elutriation leg. As a further alternative, centrifugal force may be used, such as that provided by a hydrocyclone or a centrifuge. The separation techniques just described may be repeated on the liquid slurry to create multiple streams of solids fractionated by size classes. The solids may or may not require washing and drying, according to the intended use of the beads.

Alternative methods of providing seed particles, in those instances where seed particles are provided, include those in which dry seeds are fed into the first vessel by the use of a mechanical metering device. Alternatively, the seeds may be fed as a slurry, with or without combination with all or part of one of the three liquid streams in the above description. The seeds may be recycled from the operating continuous process by one of the solid-liquid separation or fractionation processes described above, or the seeds may be generated in a separate process. Of course, if the size fractionation of solid particles is performed within the reaction vessel, the undersized particles may be retained and serve as seed particles, such that a continuous external feed stream of seeds is not required. In that event, the larger size particles are separated from the reaction mixture, and the smaller sizes retained to serve as seeds during the continuous process in which the reactants are continuously added.

In yet another aspect, the invention relates to methods and processes along the lines already described, wherein the amount of methanol provided to the reaction mixture is limited.

Formaldehyde is typically provided as a 37% solution of para-formaldehyde in water and alcohol and is termed formalin. The alcohol is usually methanol and is present at a concentration average of from about 6-14% based on the formaldehyde sample. The methanol is a good solvent for the para-formaldehyde and acts to keep the para-formaldehyde from precipitating from solution. The formalin can thus be stored and processed at low temperatures (<23° C.) without para-formaldehyde precipitating from solution. However, we have found that the use of formalin solutions with much less methanol than is typically used suitably deliver formaldehyde to the reaction and that these solutions have advantages from the yield of larger particles point of view.

The amount of methanol contained in the formalin used may thus vary. In order to stabilize the formaldehyde in solution, a methanol concentration as low as 0.50% may be used, but it may be as high as 13% or more. At low levels of methanol, the solution can become unstable and the formaldehyde may precipitate from solution, particularly at lower temperatures (<30° C.), where the formaldehyde is less soluble in the water/methanol mixture. The methanol concentration may thus be present up to about 0.50% or more, or up to about 2% or more, or up to about 7%, or up to 13% or more, or from 0 to 5%, or from 0.50% up to 13%, in each case with respect to the concentration of methanol in the formalin solution.

The resol beads thus obtained may be used for a variety of purposes, for example by curing, carbonizing, and activating the material so that it can be used as an adsorbent. Both the thermal curing prior to carbonization and the activation following carbonization may be accomplished integral with the carbonization, if the proper activation processing parameters are present during carbonization, such as a gaseous atmosphere being selected that is suitable to accomplish all three of these objectives, as further described below, or else the curing, carbonization, and activation may be accomplished in two or more discrete steps. In those cases in which sticking of the particles to one another is acceptable, a discrete thermal curing step may be omitted entirely.

Obtaining the appropriate particle size of carbonized product may be important in obtaining the desired transport and adsorption properties, and in those cases, ideally, in which a high yield of larger sized resol bead particles is desired, for example greater than 425 um, very few fines are obtained or retained that are less than 150 um.

The heating of resol beads such as those already described can generate carbonized beads having substantially the same shape as the original object, but with a higher density. Thus, upon carbonization and activation, a resol bead will produce an activated carbon bead of substantially similar shape but typically with a smaller diameter than the starting resin.

The resol beads produced according to the invention may thus be used in a variety of ways, for example by curing, carbonizing, and activating to obtain activated carbon beads.

Some typical values for these characteristics are set out below, the information given being typical of activated carbon beads made from resol beads according to the invention formed without the addition of significant amounts of additional pore forming material.

The BET surface areas of the activated carbon beads of the invention may vary within a relatively wide range, for example from about 500 m2/g to about 3,000 m2/g, or from 600 m2/g to 2,600 m2/g, or from 650 m2/g to 2,500 m2/g. Similarly, the pore volume of the activated carbon beads of the invention may vary within a relatively wide range, for example from about 0.2 to about 1.1 cc/g, or from 0.25 to 0.99 cc/g, or from 0.30 cc/g to 0.80 cc/g. Further, for example, from about 85% to about 99% of the pores may have diameters below 20 angstroms, or from about 80% to 99%, or from 90% to 97%. The apparent density of the activated carbon beads of the invention may also vary within a relatively wide range, for example from about 0.20 g/cc to about 0.95 g/cc, or from 0.25 g/cc to about 0.90 g/cc, or from 0.30 cc/g to 0.80 cc/g.

We have found that the mean particle size of activated particles is typically about 30% less than that of the resol beads from which they are formed.

The inventions may be further illustrated by the following examples of preferred embodiments, although it will be understood that these examples are included merely for purposes of illustration and are not intended to limit the scope of the invention unless otherwise specifically indicated.

### EXAMPLES

### Test Methods

Test Method to Determine Particle Size (PS) and Particle Size Distribution (PSD) of Phenolic Resol Beads: Unless otherwise indicated, particle size analysis of beads was performed using a Wild Photomakroskop M400, to acquire images of beads, while imaging processing and analysis was performed using Visilog v 5.01 (Noesis) software. The beads were dispersed on glass slides and images were captured at magnifications ranging from 10× to 100×, depending on particle size range. Each magnification was calibrated using micrometer standards. Images were recorded in bitmap format and processed using Visilog software to measure particle diameters. The number of images processed ranged from 20 to 40 and depended on particle size and magnification with the aim of collecting over a few thousand particles in order to assure that a statistically significant number of particles were captured and measured. JMP Statistical analysis software was subsequently used to calculate particle size distribution and particle statistics such as mean and standard deviation.

Pore volume and pore size distributions were measured on a Micromeritics ASAP 2000 physisorption apparatus using N₂ at 77K. The adsorption isotherm was measured from a relative pressure of 10⁻³ to 0.995. If greater detail was needed for the low end of the pore size distribution, the adsorption isotherm was also measured for CO₂ at 0° C. from a relative pressure of 10⁻⁴ to 0.03. The total pore volume for the sample was calculated from the total gas adsorption at a relative pressure of 0.9. The pore size distribution was calculated from the adsorption isotherm according to the slit pore geometry model of Horvath-Kawazoe. See Webb, P. A., Orr, C; “Methods in Fine Particle Technology”, Micromeritics Corp, 1997, p. 73.

### Examples 1-22

Examples 1-22 demonstrate that larger particle sizes may be obtained by increasing the concentration of nitrogen-containing base provided to the reaction mixture, with or without the use of previously-formed resol beads as seeds.

### Example 1

### Preparation of Beads Using 0.309 M Ammonia

To a 1-L jacketed kettle equipped with an anchor stirring paddle, condenser, and Teflon thermocouple were added liquefied phenol (162-g; 1.517-mole), 2% CMC solution in water (77 g, degree of substitution=0.9, MW=250,000), SLS (345 mg), ammonium hydroxide (9.9 g), and 37% aqueous formaldehyde (291 g; 3.59 mole). The solution was stirred at 85 rpm and heated to 75° C. for 5 hours and to 90° for one hour. After cooling to 40° C., the mixture was allowed to settle and the mother liquor was decanted. The product was washed 3 times with 300-mL of water, filtered, and dried in a fluidized dryer. The yield was 129.7 g. The particle size distribution of the product was measured using a flow-cam technique. The mean particle size was 68 μm with a standard deviation of 33 μm.

### Example 2

### Preparation of Beads Using 0.375 M Ammonia

The procedure described in Example 1 was followed except that 12.0 g of ammonium hydroxide was used. The yield was 137.4 g. The mean particle size was 81 μm with a standard deviation of 39 μm.

### Example 3

### Preparation of Beads Using 0.441 M Ammonia

The procedure described in Example 1 was followed except that 14.1 g of ammonium hydroxide was used. The yield was 125.4 g. The mean particle size was 143 μm with a standard deviation of 87 μm.

### Example 4

### Preparation of Beads Using 0.507 M Ammonia

The procedure described in Example 1 was followed except that 16.2 g of ammonium hydroxide was used. The yield was 157.3 g. The mean particle size was 165 μm with a standard deviation of 119 μm.

### Example 5

### Preparation of Beads Using 0.574 M Ammonia

The procedure described in Example 1 was followed except that 18.3 g of ammonium hydroxide was used. The yield was 176.8 g. The mean particle size was 257 μm with a standard deviation of 161 μm.

### Example 6

### Preparation of Beads Using 0.662 M Ammonia

The procedure described in Example 1 was followed except that 21.2 g of ammonium hydroxide was used. The yield was 178.6 g. The mean particle size was 362 μm with a standard deviation of 286 μm.

### Example 7

### Fed-Batch Preparation of Beads Using 0.309 M Ammonia

To a 1-L jacketed kettle equipped with an anchor stirring paddle, condenser, and Teflon thermocouple were added liquefied phenol (162-g; 1.517 mole), 2% CMC solution in water (77 g, degree of substitution=0.9, MW=250,000), and SLS (345-mg). The solution was heated to 75° C., and was stirred at 85 rpm. Ammonium hydroxide (9.9 g) was mixed with 37% aqueous formaldehyde (291 g; 3.59 mole) stabilized with methanol (10-15%) and fed to the reaction mixture at a rate of 2.7 mL/min over a 90 minute period at reaction temperature. The solution was held at 75° C. for 5 hours and then heated at 90° C. for 1 hour. After cooling to 40° C., the mixture was allowed to settle and the mother liquor was decanted. The product was washed 3 times with 300-mL of water, filtered, and dried in a fluidized dryer. The yield was 131.4 g. The particle size distribution of the product was measured using a flow-cam technique. The mean particle size was 62 μm with a standard deviation of 27 μm.

### Example 8

### Fed-Batch Preparation of Beads Using 0.375 M Ammonia

The procedure described in Example 52 was followed except that 12.0 g of ammonium hydroxide was used. The yield was 150.4 g. The mean particle size was 89 μm with a standard deviation of 42 μm.

### Example 9

### Fed-Batch Preparation of Beads Using 0.441 M Ammonia

The procedure described in Example 8 was followed except that 14.1 g of ammonium hydroxide was used. The yield was 154.5 g. The mean particle size was 130 μm with a standard deviation of 50 μm.

### Example 10

### Fed-Batch Preparation of Beads Using 0.507 M Ammonia

The procedure described in Example 8 was followed except that 16.2 g of ammonium hydroxide was used. The yield was 181.1 g. The mean particle size was 235 μm with a standard deviation of 182 μm.

### Example 11

### Fed-Batch Preparation of Beads Using 0.574 M Ammonia

The procedure described in Example 8 was followed except that 18.3 g of ammonium hydroxide was used. The yield was 188.0 g. The mean particle size was 284 μm with a standard deviation of 213 μm.

### Example 12

### Preparation of Beads Using 0.574 M Ammonia and Shorter Reaction Time

To a 1-L jacketed kettle equipped with an anchor stirring paddle, condenser, and Teflon thermocouple were added liquefied phenol (162-g; 1.517-mole), 2% CMC solution in water (77 g, degree of substitution=0.9, MW=250,000), SLS (345 mg), ammonium hydroxide (18.3 g), and 37% aqueous formaldehyde (291 g; 3.59 mole). The solution was stirred at 85 rpm and heated at 75° C. for 5 hours. After cooling to 40° C., the mixture was allowed to settle and the mother liquor was decanted. The product was washed 3 times with 300-mL of water, filtered, and dried in a fluidized dryer. The yield was 167.7 g. The particle size distribution of the product was measured using a flow-cam technique. The mean particle size was 271 μm with a standard deviation of 175 μm.

### Example 13

### Preparation of Beads Using High Surface Area of Seeds and 0.309 M Ammonia

To a 1-L jacketed kettle equipped with an anchor stirring paddle, condenser, and Teflon thermocouple were added liquefied phenol (162-g; 1.517 mole), 2% CMC solution in water (77 g, degree of substitution=0.9, MW=250,000), SLS (345 mg), ammonia (9.87 g), and 37% aqueous formaldehyde (291 g; 3.59 mole). Previously formed beads (57 g) having a mean size of 69 μm (standard deviation of 33 μm) and total calculated surface area of 4.73 m2 were added. The resulting mixture was stirred at 85 rpm and heated to 75° C. for 5 hours and to 90° for one hour. After cooling to 40° C., the mixture was allowed to settle and the mother liquor was decanted. The product was washed 3 times with 300-mL of water, filtered, and dried in a fluidized dryer. The yield was 170 g. The particle size distribution of the product was measured using a flow-cam technique. The mean particle size was 105 μm with a standard deviation of 46 μm.

### Example 14

### Preparation of Beads Using High Surface Area of Seeds and 0.375 M Ammonia

The procedure described in Example 13 was followed except that 12.0 g of ammonium hydroxide was used. The yield was 176 g. The mean particle size was 113 μm with a standard deviation of 43 μm.

### Example 15

### Preparation of Beads Using High Surface Area of Seeds and 0.441 M Ammonia

The procedure described in Example 13 was followed except that 14.1 g of ammonium hydroxide was used. The yield was 177 g. The mean particle size was 100 μm with a standard deviation of 33 μm.

### Example 16

### Preparation of Beads Using High Surface Area of Seeds and 0.507 M Ammonia

The procedure described in Example 13 was followed except that 16.2 g of ammonium hydroxide was used. The yield was 189 g. The mean particle size was 113 μm with a standard deviation of 46 μm.

### Example 17

### Preparation of Beads Using High Surface Area of Seeds and 0.574 M Ammonia

The procedure described in Example 13 was followed except that 18.3 g of ammonium hydroxide was used. The yield was 190 g. The mean particle size was 98 μm with a standard deviation of 31 μm.

### Example 18

### Preparation of Beads Using Low Surface Area of Seeds and 0.441 M Ammonia

To a 1-L jacketed kettle equipped with an anchor stirring paddle, condenser, and Teflon thermocouple were added liquefied phenol (162-g; 1.517 mole), 2% CMC solution in water (77 g, degree of substitution=0.9, MW=250,000), SLS (345 mg), ammonium hydroxide (14.1 g), and 37% aqueous formaldehyde (291-g; 3.59 mole). Previously formed beads (15 g) having a mean size of 69 μm (standard deviation of 33 μm) and total calculated surface area of 1.25 m2 were added. The resulting mixture was stirred at 85 rpm and heated to 75° C. for 5 hours. After cooling to 40° C., the mixture was allowed to settle and the mother liquor was decanted. The product was washed 3 times with 300-mL of water, filtered, and dried in a fluidized dryer. The yield was 148 g. The particle size distribution of the product was measured using a flow-cam technique. The mean particle size was 118 μm with a standard deviation of 43 μm.

### Example 19

### Preparation of Beads Using Low Surface Area of Seeds and 0.574 M Ammonia

The procedure described in Example 18 was followed except that 18.3 g of ammonium hydroxide was used. The yield was 175 g. The mean particle size was 144 μm with a standard deviation of 57 μm.

### Example 20

### Preparation of Beads Using Low Surface Area of Seeds, 0.309 M Ammonia, and Shorter Reaction Time

The procedure described in Example 18 was followed except that 9.9 g of ammonium hydroxide was used. The yield was 149 g. The product was comprised of sticky, opaque particles that were spherical while wet, but lost their spherical shape upon drying.

### Example 21

### Preparation of Beads Using Low Surface Area of Seeds, 0.309 M Ammonia, and Shorter Reaction Time

The procedure described in Example 20 was repeated with new bottles of phenol and ammonium hydroxide. The yield was 144 g. The product was comprised of sticky, opaque particles that were spherical while wet, but lost their spherical shape upon drying.

### Example 22

### Preparation of Beads Using 0.882 M Ammonia

The procedure described in Example 1 was followed except that 28.2 g of ammonium hydroxide was used. The product was comprised of mainly large, oblong particles along with smaller spherical particles of a broad size distribution. The weight of product was 173.1 g.

TABLE 1
The effect of ammonia concentration on the mean size of resin
beads

| | [NH3] | mean | standard | |
|---|---|---|---|---|
| Example | mol/kg | size | deviation | Yield (g) |
| 1 | 0.309 | 68 | 33 | 129.7 |
| 2 | 0.375 | 81 | 39 | 137.4 |
| 3 | 0.441 | 143 | 87 | 125.4 |
| 4 | 0.507 | 165 | 119 | 157.3 |
| 5 | 0.574 | 257 | 161 | 176.8 |
| 6 | 0.662 | 362 | 286 | 178.6 |
| 22 | 0.882 | | | 173.1 |
| 7 | 0.309 | 62 | 27 | 131.4 |
| 8 | 0.375 | 89 | 42 | 150.4 |
| 9 | 0.441 | 130 | 50 | 154.5 |
| 10 | 0.507 | 235 | 182 | 181.1 |
| 11 | 0.574 | 284 | 213 | 188.0 |
| 12 | 0.574 | 271 | 174 | 167.7 |

TABLE 2
The effect of ammonia concentration in the presence of seeds.

| | | wt of | mean | | |
|---|---|---|---|---|---|
| | [NH3] | seeds | size | standard | Yield* |
| Example | (mol/kg) | (g) | (μm) | deviation | (g) |
| 13 | 0.309 | 57 | 105 | 46 | 170 |
| 14 | 0.375 | 57 | 113 | 43 | 176 |
| 15 | 0.441 | 57 | 100 | 33 | 177 |
| 16 | 0.507 | 57 | 113 | 46 | 189 |
| 17 | 0.574 | 57 | 98 | 31 | 190 |
| 18 | 0.441 | 15 | 118 | 43 | 148 |
| 19 | 0.574 | 15 | 144 | 57 | 175 |
| 20 | 0.309 | 15 | | | 149 |
| 21 | 0.309 | 15 | | | 144 |

We claim:

1. A method for obtaining a predetermined mean particle size of resol beads produced in a process comprising:
forming a reaction mixture comprising a phenol, an aldehyde, and an effective-variable concentration of a nitrogen-containing base as catalyst, in an agitated aqueous medium provided with a colloidal stabilizer and optionally a surfactant, to form a reaction mixture;
allowing the reaction mixture to react for a period of time and at a temperature sufficient to produce an aqueous dispersion of resol beads; and
recovering from the aqueous dispersion resol beads, the method comprising:
selecting a predetermined mean particle size for the resol beads, and selecting a corresponding effective-variable concentration of the nitrogen-containing base in the reaction mixture according to a correlation whereby increasing the effective-variable concentration increases the mean particle size, so as to produce the desired mean particle size of the resol beads.

2. The method of claim 1, wherein the predetermined mean particle size corresponds to a mean particle diameter in the range from about 40 μm to about 500 μm.

3. The method of claim 2, wherein the predetermined mean particle size corresponds to a mean particle diameter in the range from 80 μm to 360 μm.

4. The method of claim 1, wherein the selected effective-variable concentration of the nitrogen-containing base is from about 0.3 mole to about 0.7 mole per kilogram of reaction mixture.

5. The method of claim 4, wherein the selected effective-variable concentration of the nitrogen-containing base is from 0.4 mole to 0.6 mole per kilogram of reaction mixture.

6. The method of claim 1, wherein the phenol compound and the nitrogen-containing base are present in the reaction mixture in a molar ratio from about 0.1 to about 0.24 mole of nitrogen-containing base per mole of phenol compound.

7. The method of claim 1, wherein the phenol compound comprises monohydroxybenzene.

8. The method of claim 1, wherein the aldehyde compound comprises formaldehyde.

9. The method of claim 1, wherein the nitrogen-containing base comprises one or more of ammonia or ammonium hydroxide.

10. The method of claim 1, wherein the temperature is in the range from 75° C. to 90° C.

11. The method of claim 1, wherein the time is from 4 hours to 8 hours.

12. The method of claim 1, wherein the colloidal stabilizer comprises carboxymethylcellulose (CMC).

13. The method of claim 1, wherein the reaction mixture includes a surfactant.

14. The method according to claim 1, wherein the reaction mixture further comprises previously-formed resol beads.

15. The method according to claim 14, wherein the previously-formed resol beads have a median particle size from 75 μm to 750 μm.

16. The method according to claim 15, wherein the resol beads recovered have a median particle size from 10 μm to 2,000 μm.

17. The method according to claim 14, wherein the previously-formed resol beads are provided in an amount of at least 10 wt. %, based on the weight of the phenol.

18. The method according to claim 1, wherein the molar ratio of the aldehyde to the phenol is from 1.1:1 to 3:1.

19. The method according to claim 1, wherein the method further comprises:
optionally thermally curing the recovered resol beads in a heated fluid, with agitation, to obtain at least partially cured beads; and
carbonizing and activating the resulting beads to obtain activated carbon beads.

20. The method according to claim 19, wherein the optional thermal curing is carried out in a fluid that is different from the aqueous medium in which the resol beads are formed.

21. The method according to claim 20, wherein the carbonizing and activating are accomplished in the same gaseous atmosphere.

22. The method according to claim 1, wherein the recovered resol beads are thermally cured in a heated fluid, with agitation, to obtain cured resol beads.

23. The method according to claim 22, wherein the thermal curing is carried out in a fluid that is different from the aqueous medium in which the resol beads are formed.

24. The method according to claim 22, wherein the heated fluid comprises one or more of: liquid water, steam, air, nitrogen, or an inert gas.

25. The method according to claim 22, wherein the thermal curing is carried out under a vacuum.
